(19) United States
(12) Patent Application Publication
(10) Pub. No.: US 2025/0186945 A1
(43) Pub. Date: Jun. 12, 2025

(54) MEMBRANE WITH A REDUCTION IN A DIMENSIONAL PROPERTY

(71) Applicant: EVOVE LTD, Manchester (GB)

(72) Inventors: Omkar Shrikant JOSHI, Manchester (GB); Tristan PHILLIPS, Manchester (GB)

(21) Appl. No.: 18/842,252

(22) PCT Filed: Mar. 3, 2023
(86) PCT No.: PCT/GB2023/050509

§ 371 Date: Aug. 28, 2024

(30) Foreign Application Priority Data
Mar. 4, 2022 (GB) 2203080.3

(51) Int. Cl. B01D 61/02; B01D 61/14; B01D 67/00; B01D 69/02; B33Y 10/00; B33Y 80/00

(52) U.S. Cl. CPC B01D 61/027; B01D 61/145; B01D 61/147; B01D 67/00415; B01D 69/02; B33Y 10/00; B33Y 80/00

(57) ABSTRACT

A membrane a feed flow inlet, a retentate flow outlet and a permeate flow outlet. The membrane further includes a membrane interface portion comprising a plurality of feed flow channels fluidly connected to the feed flow inlet and to the retentate flow outlet, and a plurality of permeate flow channels fluidly connected to the permeate flow outlet, wherein the membrane interface portion is operable to allow for fluid communication between the feed flow channels and the permeate flow channels through a membrane portion. The membrane interface portion includes a reduction in a dimensional property from toward the feed flow inlet to toward the retentate flow outlet so that the membrane interface portion is operable to produce a higher cross-flow velocity at the membrane portion toward the retentate flow outlet. Also provided is a water treatment module including the membrane and a process for making the membrane.

### FIELD

The present invention relates to a membrane. More specifically, the present invention relates to a membrane for water treatment.

### BACKGROUND

Conventional methods of water treatment such as chemical disinfection, solar disinfection, boiling, sedimentation and distillation are not sufficient to meet the portable water requirement of the world's population at low cost. In order to tackle the problem, more advanced technologies have been established and industrialized, such as pressure-driven membrane-based water treatment technologies which in general include ultrafiltration (UF), microfiltration (MF), nanofiltration (NF), and reverse osmosis (RO). By providing the advantages of circumventing the application of thermal inputs, chemical additives and reducing medium regeneration, these methods have significantly improved the water treatment industry.

Membrane filtration is favoured over other water treatment technologies due to, in principle, no significant thermal input, fewer chemical additives and a lower requirement for the regeneration of spent media. Pressure-driven membrane processes are the most widely applied membrane technologies in water treatment, for the removal of particulates, ions, microorganisms, bacteria, and natural organic materials, covering different applications from waste treatment from the food and oil industry to seawater desalination.

Typically, separation membranes are categorised in accordance with the characteristic pore size or intended applications. Microfiltration membranes (MF), with pore sizes in a range of 0.1 μm to 100 μm, can be used to remove bacteria, cysts, yeast cells, suspending particles, pigments, and asbestos. Ultrafiltration membranes (UF), having pore sizes in a range of 0.01 μm and 0.1 μm, can be used to remove proteins, colloidal particles and viruses. Nanofiltration membranes (NF), with pore sizes in the range of from 0.001 to 0.01 μm, can be used to select multivalent ions, dissolved compounds, medium sized organic molecules, small proteins, small colloidal particles. Reverse osmosis membranes (RO), with pore sizes smaller than 0.001 μm, can be used to remove ions and small organic molecules.

However, when using current membrane systems for water treatment a layer of particles in high concentration forms adjacent to the membrane surface, which creates resistance for the water to permeate through the membrane. Over time, the concentration in this layer increases, which further increases resistance to the water permeating through the membrane thereby causing a reduction in the flux over time. Furthermore, the ongoing flux continually increases the concentration of particles near the membrane. After a while, the concentration of particles at the membrane surface becomes high enough that there is a steep concentration gradient in the vicinity of the membrane surface. This results in the diffusion of particles from the membrane surface to the bulk feed flow. Eventually, an equilibrium is reached between the rate of transport of particles due to convection (from bulk feed flow to membrane surface) and diffusion (from membrane surface to the bulk feed flow), thus flux stabilizes, although at a level significantly lower than the initial flux. This phenomenon is known as concentration polarization (CP) and the region of high concentration adjacent to the membrane is called a concentration polarization (CP) layer. While a CP layer is typically reversible and only exists when the flow has been established, over time it can become compact and begin to irreversibly foul the membrane, affecting flux even further.

The drive to produce new clean water resources and protect existing water resources at lower capital and operating costs demands improved and tuneable fouling resistance, higher yield at lower energy inputs, longer life span and improved chemical and mechanical resistance.

Accordingly, improved membrane systems and processing technologies for efficient water treatment having properties to fulfil the demands are desired.

It is therefore an object of aspects of the present invention to address one or more of above-mentioned or other problems.

### SUMMARY

According to a first aspect of the present invention, there is provided a membrane comprising:
a feed flow inlet,
a retentate flow outlet,
a permeate flow outlet,
a membrane interface portion comprising a plurality of feed flow channels fluidly connected to the feed flow inlet and to the retentate flow outlet, and a plurality of permeate flow channels fluidly connected to the permeate flow outlet, wherein the membrane interface portion is operable to allow for fluid communication between the feed flow channels and the permeate flow channels through a membrane portion,
wherein the membrane interface portion comprises a reduction in a dimensional property from toward the feed flow inlet to toward the retentate flow outlet so that the membrane interface portion is operable to produce a higher cross-flow velocity at the membrane portion toward the retentate flow outlet.

According to a second aspect of the present invention, there is provided a membrane, suitably a membrane according to the first aspect of the present invention, wherein the membrane is obtainable by additive manufacturing.

According to a third aspect of the present invention, there is provided a method of preparing a membrane, suitably a membrane according to the first or second aspect of the present invention, the method comprising:
a. producing the membrane by additive manufacturing.

According to a fourth aspect of the present invention, there is provided a method of separating a component from a feed flow composition, comprising:
a. introducing a feed flow composition into a membrane according to any of the first to third aspects of the present invention so that the feed flow contacts the membrane;
b. effecting separation of at least a portion of the component from the feed flow through the membrane of the membrane into a permeate flow composition.

According to a fifth aspect of the present invention, there is provided a water treatment module comprising a membrane according to any of the first to third aspects of the present invention.

Advantageously, employing a membrane according to any of the first to fifth aspects of the present invention, wherein the membrane interface portion proximal to the feed flow inlet has a larger average dimensional property than the membrane interface portion distal to the feed flow inlet, the cross-flow velocities (and hence shear on the membrane) of the feed may be enhanced towards the distal end of the membrane. The increased shear on the membrane surface may improve the flux towards the distal end of the membrane, compensating for the depleted pressure in this region and thus may produce a more uniform flux through the length of the membrane. Moreover, the increased cross-flow velocity towards the distal end of the membrane may also remove the particles near the membrane surface more effectively, thus this region is less likely to be fouled, which is especially advantageous when considering that this region may have lower pressure.

A reduction in a dimensional property according to the present invention may also result in smaller pressure drop across the membrane compared to that with a membrane with uniform values from proximal to distal end for the same amount of flux and feed flow rate.

Advantageously, the membrane according to the present invention may require lower energy per unit volume of the permeate produced, known as specific energy consumption (or SEC), compared to that required with a membrane with uniform values from proximal to the distal end, for the same amount of flux and feed flow rate.

As used herein “closer to the feed flow inlet”, “toward the feed flow inlet” or “proximal end” and the like may mean in terms of the distance along the flow path of the feed flow from the feed flow inlet.

As used herein “closer to the retentate flow outlet”, “toward the retentate flow outlet” or “distal end” and the like may mean in terms of the distance along the flow path of the feed flow from the retentate flow outlet.

While it will be appreciated that parts of the feed flow path may extend laterally, the overall feed flow direction may be from a first end of the membrane to a second, substantially opposed, end of the membrane. In such a manner, the membrane may be considered to have an overall feed flow direction axis (e.g. in the Z direction). The membrane may comprise a feed flow inlet arranged toward a first end of the membrane with a retentate outlet and/or a permeate outlet at a second end of the membrane. The first and second ends may be at substantially longitudinally opposed ends of the membrane. As such, the overall feed flow direction axis may extend along the longitudinal length of the membrane.

The membrane may comprise lateral axes extending substantially transversely (e.g. in the X, Y direction) to the overall feed flow direction axis.

The feed flow inlet may refer to a channel operable to deliver the feed flow to the membrane interface portion. The feed flow inlet may not allow for direct fluid communication with the permeate flow outlet.

The retentate flow outlet may refer to a channel operable to carry the retentate flow away from the membrane interface portion. The retentate flow outlet may not allow for direct fluid communication with the permeate flow outlet.

The permeate flow outlet may refer to a channel operable to carry the permeate flow away from the membrane interface portion. The permeate flow outlet may not allow for direct fluid communication with the feed flow inlet.

The unit cells may be abutting, such as integrally formed so as to form a continuous structure. The unit cells may integrally formed by additive manufacture.

The membrane interface portion may comprise a first unit cell layer and a second unit cell layer, wherein each unit cell layer extends substantially transversely to the direction of feed flow, and wherein each unit cell layer comprises a plurality of unit cells.

The unit cells of the first and second layer may each comprise a feed flow channel portion, a permeate flow channel portion and a membrane portion separating the feed flow portion and the permeate flow portion.

The feed flow channel portion and the permeate flow channel portion of a unit cell may be fluidly connected to the feed flow channel portion and the permeate flow channel portion of an adjacent unit cell.

The plurality of unit cells in the first unit cell layer may comprise an average dimensional property that is larger than the average of the same dimensional property in the plurality of unit cells in the second unit cell layer and the first unit cell layer may be arranged closer to the feed flow inlet than the second unit cell layer. In such an arrangement, the membrane interface portion may comprise a reduction in a dimensional property from toward the feed flow inlet to toward the retentate flow outlet so that the membrane interface portion is operable to produce a higher cross-flow velocity at the membrane portion toward the retentate flow outlet.

Accordingly, according to a further aspect of the present invention, there is provided a membrane comprising:
a feed flow inlet,
a retentate flow outlet,
a permeate flow outlet,
a membrane interface portion comprising a plurality of feed flow channels fluidly connected to the feed flow inlet and to the retentate flow outlet, and a plurality of permeate flow channels fluidly connected to the permeate flow outlet, wherein the membrane interface portion is operable to allow for fluid communication between the feed flow channels and the permeate flow channels through a membrane portion,
wherein the membrane interface portion comprises a first unit cell layer and a second unit cell layer, wherein each unit cell layer extends substantially transversely to the direction of feed flow, and wherein each unit cell layer comprises a plurality of unit cells,
wherein the unit cells of the first and second layer each comprise a feed flow channel portion, a permeate flow channel portion and a membrane portion separating the feed flow portion and the permeate flow portion,
wherein the feed flow channel portion and the permeate flow channel portion of a unit cell is fluidly connected to the feed flow channel portion and the permeate flow channel portion of an adjacent unit cell,
and wherein the plurality of unit cells in the first unit cell layer comprise an average dimensional property that is larger than the average of the same dimensional property in the plurality of unit cells in the second unit cell layer,
and wherein the first unit cell layer is arranged closer to the feed flow inlet than the second unit cell layer.

The following features may apply to any of the first to fifth or further aspects of the present application.

The “average dimensional property” may be the average calculated from the respective value in each of the unit cells of the layer. Such values may be measured by any suitable method well known to the skilled person. It will be apparent that the unit cells of a unit cell layer may also have variance in a dimensional property relative to other unit cells of the layer. The variance between unit cells of the same unit cell layer may be less than the average variance in the dimensional property between different unit cell layers, such as at least 10% less, at least 25% less or at least 30% less.

The first unit cell layer may be operable to receive higher transmembrane pressure (TMP), than the second unit cell layer due to being proximate to the feed flow inlet compared to the second unit cell layer.

The first unit cell layer may be the first unit cell layer of the membrane interface portion. As such, the first unit cell layer may be directly adjacent to the feed flow inlet. The second unit cell layer may be the last unit cell layer of the membrane interface portion. As such, the second unit cell layer may be directly adjacent to the retentate flow outlet.

The membrane interface portion may comprise a plurality of unit cell layers wherein the plurality of unit cells in each subsequent, but not necessarily directly adjacent, unit cell layer extending from proximal to the feed flow inlet to distal to the feed flow inlet have a reducing average dimensional property. As used herein, “plurality” with respect to the number of unit cell layers may mean at least 3, such as at least 6, or at least 10. In such a manner, the membrane of the present invention may provide a gradient of reducing dimensional property extending from a highest level proximal to the feed flow inlet to a lower level distal to the feed flow inlet.

The plurality of unit cells of the first and/or second unit cell layer may be in the form of periodically repeating unit cell shapes.

As used herein “periodically repeating unit cell shape” may mean that the repeating unit cells have substantially the same three-dimensional shape. The unit cells may however independently have a difference in the size of a dimensional property, such as overall size, wall thickness and/or size of a void space. For example, the shape may have been subjected to scaling, whether in one or more dimensions and with respect to the overall size, wall thickness and/or void space. The lateral and/or feed flow direction dimension of the shape may be scaled to provide a different lateral and/or feed flow direction aspect ratio while maintaining substantially the same three-dimensional shape.

As used herein ‘a plurality’ with respect to the number of unit cells may mean at least 3, such as at least 5, at least 10 or at least 15.

The membrane interface portion comprises a reduction in a dimensional property from toward the feed flow inlet to toward the retentate flow outlet so that the membrane interface portion is operable to produce a higher cross-flow velocity at the membrane portion toward the retentate flow outlet.

The dimensional property may be a dimension extending along the overall feed flow direction axis and/or a dimension extending along a lateral axis, such as the average overall feed flow direction aspect ratio and/or the average lateral (X and Y) aspect ratio.

As used herein, the ‘overall feed flow direction aspect ratio’ may be defined as the ratio of the overall feed flow direction size of the unit cell (in Z direction) to the average lateral cell size (the average of the size in X and Y directions) of the unit cell layer having the largest average unit cell lateral dimension in the membrane interface. As such, the average lateral cell size of the unit cell layer having the largest average unit cell lateral dimension in the membrane interface may be the reference point against which the aspect ratios of the further unit cell layers are calculated. The “lateral aspect ratio” may be defined as the ratio of the average lateral size of the unit cell (average of the size of the X and Y directions) to the average lateral unit cell size (the average of the size in X and Y directions) of the unit cell layer having the largest average unit cell lateral dimension in the membrane interface.

Accordingly, ‘overall feed flow direction aspect ratio may be a measure of stretching by scaling in feed flow (Z) direction, with a lower aspect ratio corresponding to less stretching of the membrane interface portion. Similarly, the ‘lateral’ aspect ratio may be a measure of scaling the membrane interface portion laterally (X and/or Y directions), such as a measure of scaling the membrane interface portion inwardly.

The difference in the overall feed flow direction aspect ratio between the first and second unit cell layers may be operable to increase the average flow path the feed has to traverse for the same distance along the overall feed flow direction axis. Thus for the same flow rate, cross-flow velocity in the second unit cell layer may be higher. The difference in the lateral aspect ratio between the first and second unit cell layer may also be operable to reduce the volume and the cross-section area of the feed channels in the second unit cell layer compared to that in the first unit cell layer and hence, considering incompressible flow, the feed flow may have to accelerate to conserve the mass (and volume) and consequently the average velocity in the second unit cell layer may increase. As a result, the cross-flow velocity at the surface of membrane portions on the feed flow sides may be higher in the second unit cell layer compared to the first unit cell layer. The shear on the membrane surface may be positively influenced by higher cross-flow velocities, as such the average values of shear on the membrane surface may be higher in the second unit cell layer compared to the first unit cell. This may assist with disrupting the concentration polarization layer more effectively in this region and thereby reduce the hydraulic resistance it can cause, which may allow for more permeate to pass through the membrane portion.

The first unit cell layer may comprise a higher average lateral aspect ratio than the second unit cell layer.

The first unit cell layer may comprise an average lateral aspect ratio of at least 0.2, such as at least 0.5. The first unit cell layer may comprise an average lateral aspect ratio of up to 1. The first unit cell layer may comprise an average lateral aspect ratio of from 0.2 to 1, such as from 0.5 to 1.

The second unit cell layer may comprise an average lateral aspect ratio of at least 0.1, such as at least 0.4. The second unit cell layer may comprise an average lateral aspect ratio of up to 0.99, such as up to 0.8. The second unit cell layer may comprise an average lateral aspect ratio of from 0.1 to 0.99, such as from 0.4 to 0.8.

The first unit cell layer may comprise a higher average feed flow direction aspect ratio than the second unit cell layer.

The first unit cell layer may comprise an average feed flow direction aspect ratio of at least 0.5. The first unit cell layer may comprise an average feed flow direction aspect ratio of up to 10, such as up to 4. The first unit cell layer may comprise an average feed flow direction aspect ratio of from 0.5 to 10, such as from 0.5 to 4.

The second unit cell layer may comprise an average feed flow direction aspect ratio of at least 0.1, such as at least 0.3. The second unit cell layer may comprise an average feed flow direction aspect ratio of up to 5, such as up to 3. The second unit cell layer may comprise an average feed flow direction aspect ratio of from 0.1 to 5, such as from 0.3 to 3.

The lateral and/or feed flow direction aspect ratio of the membrane may decrease from a portion of the membrane interface portion that is proximal to the feed flow inlet to the portion of the membrane interface portion that is distal to the feed flow inlet, for example the aspect ratio of the membrane may decrease from the feed flow inlet to the retentate flow outlet of the membrane, such as through a plurality of unit cell layers. Advantageously, this arrangement may establish a gradient in the cross-flow velocities in the membrane such that the cross-flow velocities at the distal end are enhanced and the resulting high shear helps improve flux in this region, compensating for the depleted transmembrane pressure and producing a more uniform flux.

The dimensional property, such as an aspect ratio, may vary along the membrane interface portion unit cell layers according to a gradient, such as along a linear gradient, along an exponential gradient and/or along a polynomial gradient.

The reduction in a dimensional property may be a reduction in the wall thickness of the membrane interface portion, such as a reduction in the wall thickness of the membrane portion. The second unit cell layer may comprise a smaller average wall thickness than the first unit cell layer.

The membrane interface divides its volume into feed and permeate regions and the trans-membrane pressure (TMP), which is governed by the average of feed and retentate pressures, is the force that drives the flow through the membrane interface from the feed channels to the permeate channels. Advantageously, thinner membrane walls in the second unit cell layer distal to the feed flow inlet may help increase the flux in the distal region. The transmembrane pressure may reduce from the proximal end to the distal end of the membrane interface portion, and while a larger thickness may be required towards the proximal end for structural support, a smaller thickness may be sufficient toward the distal end. Thus, with reduced thickness from toward the proximal end to toward the distal end, more flux may be generated due to the thinner walls presenting lower hydraulic resistance, despite this region having depleted pressure.

The first unit cell layer may have an average thickness ratio of at least 0.5, such as at least 0.8. The first unit cell layer may have an average thickness ratio of up to 1. The first unit cell layer may have an average thickness ratio of from 0.5 to 1, such as from 0.8 to 1.

The first unit cell layer may have an average wall thickness of ≥0.3 mm, such as ≥0.5 mm. The first unit cell layer may have an average thickness of ≤5 mm, such as ≤3 mm. The first unit cell layer may have an average thickness of from between 0.3 mm to 5 mm, such as from 0.5 to 3 mm.

The second unit cell layer may have an average thickness ratio of at least 0.1, such as at least 0.4. The second unit cell layer may have an average thickness ratio of up to 0.99, such as up to 0.8. The second unit cell layer may have an average thickness ratio of from 0.1 to 0.99, such as from 0.4 to 0.8.

The second unit cell layer may have an average wall thickness of ≥0.2 mm, such as ≥0.4 mm. The second unit cell layer may have an average thickness of ≤4 mm, such as ≤2 mm. The second unit cell layer may have an average thickness of from between 0.2 mm to 4 mm, such as from 0.4 to 2 mm.

As used herein, the “thickness ratio” may be defined as the ratio of the average thickness of the walls of the unit cell to the average thickness of the unit cell layer having the largest average unit cell wall thickness dimension in the membrane interface.

The unit cells are suitably fluidly connected so that the feed flow can pass from the feed flow portion of one unit cell to the feed flow portion of another adjacent unit cell, and/or so that the permeate flow can pass from the permeate flow portion of one unit cell to the permeate flow portion of another unit cell.

The periodically repeating unit cell shape may comprise a triply periodic unit cell shape.

The periodically repeating unit cell shape may comprise a gyroid structure with a gradient, suitably a linear gradient, changing bias length; a gyroid structure with (linear) gradient changing wall thickness; and/or a diamond lattice structure with (linear) gradient changing strut thickness.

The unit cell may have a largest dimension of ≥0.5 mm, such as ≥0.7 mm, or ≥0.9 mm. The unit cell may have a largest dimension of ≤100 mm, such as ≤70 mm, or ≤50 mm. The unit cell may have a largest dimension of from 0.5 to 100 mm, such as from 0.7 to 70 mm, or from 0.9 to 50 mm.

The shape of the unit cell may be a diamond structure, a cubic structure, a fluorite structure, an octet structure, a Kelvin cell structure, an iso-truss structure, a hex prism diamond structure, a truncated tube structure, a truncated octahedron structure, a Weaire-Phelan structure, a body centred cubic structure, and/or a face centred cubic structure.

A triply periodic unit cell may comprise a triply periodic minimal surface unit cell, such as selected from a gyroid structure, a schwarz P structure, a schwarz D structure, a schwarz CLP structure, a schwarz H structure, a splitP structure, a neovius structure, or a double gyroid structure.

The internal void volume of the feed channels of the membrane interface portion may be larger than the internal void volume of permeate channels. The average width of the feed flow channel of a unit cell may be larger than the average width of the permeate flow channel of the unit cell.

The ratio of the average width of the feed flow channel portion of a unit cell to the average width of the permeate flow channel portion of the unit cell may be at least 1:1, such as at least 1.1:1. The ratio of the average width of the feed flow channel portion of a unit cell to the average width of the permeate flow channel portion of a unit cell may be up to 3:1, such as up to 1.8:1. The ratio of the average width of the feed flow channel portion of a unit cell to the average width of the permeate flow channel portion of a unit cell may be from 1:1 to 3:1, such as from 1.1:1 to 1.8:1.

The unit cell may comprise a feed flow channel portion having an average width of ≥2 mm, such as ≥5 mm. The unit cell may comprise a feed flow channel portion having an average width of ≤50 mm, such as ≤20 mm. The unit cell may comprise a feed flow channel portion having an average width of from 2 to 50 mm, such as from 5 to 20 mm.

The unit cell may comprise a permeate flow channel portion having an average width of ≥1.5 mm, such as ≥3 mm. The unit cell may comprise a permeate flow channel portion having an average width of ≤40 mm, such as ≤15 mm. The unit cell may comprise a permeate flow channel portion having an average width of from 1.5 to 40 mm, such as from 3 to 15 mm.

The membrane may have a tensile strength operable to withstand the feed application pressure of ≥0.5 MPa, such as ≥1 MPa or ≥2 MPa, optionally, in the range of from 2 MPa to 200 MPa. The tensile strength of the ceramic membrane may be measured according to ASTM C1273-18.

The membrane may have an open porosity of at least 10%, such as at least 20%, such as at least 30%, such as at least 40%, such as at least 50%. The membrane may have an open porosity of from 10% to 60%, such as from 15% to 50%, such as from 20% to 40%. A nanofiltration membrane may have an open porosity of from 10% to 40%, such as from 10% to 30%.

As used herein, the “open porosity” may be the volume of pores that are interconnected from one side of the membrane to the other, for example from a feed side of the membrane to a permeate side of the membrane, also known as ‘connected porosity’ or ‘effective porosity’. The open porosity may be measured by optical and electronic examination of the cross-section of the membrane using any suitable microscopy techniques. The open porosity may be measured by capillary flow porometry (used for 50 nm to 500 μm). The open porosity may be measured by Nano-Perm Porometer (used for 0.5 to <50 nm).

The membrane may have a closed porosity of from 0 to 90%, such as from 10 to 60%, such as from 20 to 40%. The closed porosity is the volume of voids that either have no connection to either side of the membrane, for example, no connection to a feed inlet of the membrane or to a permeate outlet of the membrane, or has connection only to one side but not the other (also known as dead-end pores). The closed porosity may be measured by optical and electronic examination of cross-section of the membrane using any suitable microscopy techniques, such as Transmission Electron Microscopy (TEM) and/or Scanning Electron Microscopy (SEM).

The membrane may have a total porosity (also known as ‘bulk porosity’) of at least 40%, such as at least 50%, such as at least 60%. The total porosity is the sum of the open porosity and the closed porosity. The total porosity may be measured by optical and electronic examination of cross-section of the membrane using any suitable microscopy techniques. The total porosity may be measured by the Archimedes porosity determination method.

The membrane may be a microfiltration membrane. The microfiltration membrane, or a mode therein in a multi-model pore distribution, may comprise a pore size of from 0.01 μm to 10 μm, such as from 0.05 μm to 5 μm, such as about 0.1 μm. The microfiltration membrane, or a mode therein in a multi-model pore distribution, may have a pore size distribution comprising a D50 pore size of from 0.01 μm to 10 μm, such as from 0.05 μm to 5 μm, such as about 0.1 μm. The microfiltration membrane, or a mode therein in a multi-model pore distribution, may have a pore size distribution comprising a D10 pore size of at least 0.01 μm, such as at least 0.05 μm. The microfiltration membrane, or a mode therein in a multi-model pore distribution, may have a pore size distribution comprising a D90 pore size of up to 10 μm, such as up to 5 μm. A microfiltration membrane may be operable to remove particles from a liquid stream with an average particle size of at least 0.1 μm.

The membrane may be an ultrafiltration membrane. The ultrafiltration membrane, or a mode therein in a multi-model pore distribution, may comprise a pore size of from 5 nm to 1 μm, such as from 5 nm to 0.1 μm, such as about 0.01 μm. The ultrafiltration membrane, or a mode therein in a multi-model pore distribution, may have a pore size distribution comprising a D50 pore size of from 5 nm to 1 μm, such as from 5 nm to 0.1 μm, such as about 0.01 μm. The ultrafiltration membrane, or a mode therein in a multi-model pore distribution, may have a pore size distribution comprising a D10 pore size of at least 5 nm. The ultrafiltration membrane, or a mode therein in a multi-model pore distribution, may have a pore size distribution comprising a D90 pore size of up to 1 μm, such as up to 0.1 μm, such as up to 0.01 μm. An ultrafiltration membrane may remove particles from a liquid stream of 0.01 μm or larger.

The membrane may be a nanofiltration membrane. The nanofiltration membrane, or a mode therein in a multi-model pore distribution, may comprise a pore size from 0.1 nm to 100 nm, such as from 0.5 nm to 50 nm, such as from 1 nm to 10 nm, such as from 1 nm to 2 nm, or from 2 to 10 nm. The nanofiltration membrane, or a mode therein in a multi-model pore distribution, may have a pore size distribution comprising a D50 pore size from 0.1 nm to 100 nm, such as from 0.5 nm to 50 nm, such as from 1 nm to 10 nm, such as from 1 nm to 2 nm, or from 2 to 10 nm. The nanofiltration membrane, or a mode therein in a multi-model pore distribution, may have a pore size distribution comprising a D10 pore size of at least 0.1 nm, such as at least 0.5 nm, such as at least 1 nm, such as at least 2 nm. The nanofiltration membrane, or a mode therein in a multi-model pore distribution, may have a pore size distribution comprising a D90 pore size of up to 100 nm, such as up to 50 nm, such as up to 10 nm, such as up to 2 nm. A nanofiltration membrane may remove particles from a liquid stream of 1 nm or larger, such as 2 nm or larger.

The pore size of the ceramic membrane (the pore diameter) may be measured by any suitable technique known in the art. The pore size of the ceramic membrane may be measured by gas permeation based on the gas flow in the porous sample. The pore size of the ceramic membrane (used for 5 nm-1 mm) may be measured by mercury intrusion porosimetry using NIST standards. The pore size of the ceramic membrane (used for 0.5 nm-<5 nm) may be measured by nitrogen adsorption at 77K using BJH or HK methods as appropriate.

The membrane may be a ceramic membrane, a metal membrane and/or a plastic membrane.

The ceramic membrane may be formed from any suitable material. The ceramic membrane may comprise alumina, aluminum nitride, aluminum oxide, barium titanate, beta-tricalcium phosphate, biological ceramics, bismuth, boron carbide, carbides, hydroxyapatite, iron oxide, magnesium silicates, nitrides, oxides, silicon aluminum, silica, silicon carbide, silicon dioxide, silicon nitride, titanate, titanium dioxide, yttrium carbonate, YSZ (yttria stabilised zirconia), zinc oxide, zirconate, zirconia and/or zirconium, or a mixture thereof.

The feed flow inlet may refer to a channel operable to deliver the feed flow to the membrane interface portion. The feed flow inlet may not allow for direct fluid communication with the permeate flow outlet.

The retentate flow outlet may refer to a channel operable to carry the retentate flow away from the membrane interface portion. The retentate flow outlet may not allow for direct fluid communication with the permeate flow outlet.

The permeate flow outlet may refer to a channel operable to carry the permeate flow away from the membrane interface portion. The permeate flow outlet may not allow for direct fluid communication with the feed flow inlet. The membrane of the present invention may be obtainable by an additive manufacturing process. The additive manufacturing technique may be any suitable 3D printing technology. For example, the membrane disclosed herein may be printed using a vat photopolymerization, such as stereolithography (SLA); digital light processing; two-photon polymerisation; two colour photo-polymerisation; inkjet printing; binder jet printing; direct ink writing; three-dimensional printing; selective laser sintering; selective laser melting; laminated object manufacturing, and/or fused deposition modelling.

The membrane of the present invention may be obtainable by a digital light processing or binder jet printing.

A process for the production of a membrane according to the present invention by additive manufacturing may comprise the steps of:
a. providing a layer of a powder on a powder bed,
b. selectively depositing a binder onto the layer of powder,
c. repeating steps (a)-(b) to form a 3D printed green body.

A process for the production of a membrane according to the present invention by additive manufacturing may further comprise the steps of
d. optionally post-processing the 3D printed green body to form the membrane.

A process for the production of a membrane according to the present invention by additive manufacturing may comprise the steps of:
a. providing a layer of powder on a powder bed;
b. selectively bonding a portion of the powder with a binder comprising a nano- and/or micro-particle precursor;
   optionally, forming the nano- and/or micro-particle precursor into nano- and/or micro-particles,
c. repeating steps (a)-(b) to from a 3D printed green body;
   optionally, forming the nano- and/or micro-particle precursor into nano- and/or micro-particles,
wherein the nano- and/or micro-particle precursor are formed into nano- and/or micro-particles during the production of the membrane.

A process for the production of a membrane according to the present invention by additive manufacturing may further comprise the steps of
d. optionally post-processing the 3D printed green body to form the membrane and optionally forming the nano- and/or micro-particle precursor into nano- and/or micro-particles in a further post-processing step.

The membrane may be produced by an additive manufacturing process as disclosed herein.

After selectively bonding a portion of the powder, the powder bed may be lowered, and a further layer of powder is spread over the previous layer. The bed may be lowered by the distance of a layer thickness. The process may be repeated until the entire green body has been made. The green body is formed of the powder in all layers that are bound together by the binder. The powder that is not selectively bonded together does not form part of the green body.

The process of additive manufacturing may provide multiple green bodies in a single powder bed.

The powder bed may comprise a heating portion, such as a heated powder bed. A heated powder bed may be suitable to maintain the powder on the powder bed at an elevated temperature during the 3D printing process. The heated powder bed may maintain the ceramic powder and binder at an elevated temperature during the 3D printing process. The heated powder bed may be operable to elevate the temperature of a 3D printed part during the 3D printing process. The heated powder bed may heat the bed and/or the part to at least 50° C., such as at least 80° C., such as at least 100° C. The heated powder bed may heat the bed and/or the part to up to 400° C., such as up to 350° C., such as up to 300° C. The heated powder bed may heat the bed and/or the part from 50 to 400° C., such as from 80 to 350° C., such as from 100 to 300° C. The heating portion may comprise a heater system located under the powder bed, such that the bed itself is directly heated, or proximal to the powder bed such that the bed is indirectly heated.

The process may further comprise the step of heating the powder on the powder bed. The process may further comprise the step of heating the powder on the powder bed during and/or after each application of the binder in step (b) in the above processes. Steps a), b) and/or c) of the above processes may all be completed whilst the bed is at an elevated temperature. An elevated bed temperature during 3D printing advantageously improves the structural properties of the 3D printed green body (e.g. the tensile strength) which may improve the ability of the 3D printed green body to be functional as a membrane.

The optional post-processing of the 3D printed green body in step (d) in the above processes may include depowdering the 3D printed green body. Depowdering is the removal of excess powder which has not bound together with the binder and is not part of the 3D printed green body. The excess powder may be removed from the 3D printed green body in a depowdering step which may comprise being agitated/shaken and/or being exposed to an air flow.

A post-processing step as discussed herein may be a de-binding step. The de-binding step may be a thermal de-binding step and/or a solvent de-binding step.

A thermal de-binding step may comprise heating the green body at ambient pressure in an oxidative or non-oxidative atmosphere or under vacuum. Temperature, speed and duration of heating may be controlled so that the binder is removed without affecting the order of the particle packing or causing any new defects in the body.

The thermal de-binding step may comprise heating the green body to at least 200° C., such as at least 300° C., such as at least 400° C. The thermal de-binding step may comprise heating the green body to up to 1000° C., such as up to 800° C., such as up to 600° C. The thermal de-binding step may comprise heating the green body to from 200 to 1000° C., such as from 300 to 800° C., such as from 400 to 600° C.

Step (d) in the above processes may also include an infiltration step. Infiltration step is the further addition of additional binder which may be used to increase mechanical strength.

Step (d) in the above processes may also include a surface smooth process. Surface smooth process may be completed by any suitable technique known in the art, for example, by abrasive flow machining wherein a fluid comprising a polymer and an abrasive such as silicon carbide, is passed over the 3D printed green body and/or a ceramic membrane, to erode any surface irregularities or protrusions.

The post-processing step (d) in the above processes may comprise heating the 3D printed green body to at least 300° C., such as at least 500° C., such as at least 750° C., such as at least 1000° C. The post-processing step (d) may comprise heating the 3D printed green body at up to 1400° C., such as up to 1000° C., such as up to 750° C., such as up to 500° C. The post-processing step (d) may comprise heating the 3D printed green body from 300 to 1400° C., such as from 300 to 1000° C., such as from 500 to 750° C.

The post-processing step (d) in the above processes may comprise heating the 3D printed green body for at least 20 minutes, such as at least 1 hour, such as at least 4 hours, such as at least 10 hours. The post-processing step (d) may comprise heating the 3D printed green body for up to 40 hours, such as up to 36 hours, such as up to 24 hours, such as up to 10 hours. The post-processing step (d) may comprise heating the 3D printed green body from 1 to 40 hours, such as from 4 to 36 hours, such as from 10 to 24 hours.

The resulting post-processed green body is also known as a “brown body”. The green body and/or brown body may be optionally sintered in a sintering step to form the ceramic membrane.

The sintering step may comprise heating the green body and/or brown body at ambient pressure in an oxidative or non-oxidative atmosphere or under vacuum. The sintering step may comprise heating the green body and/or brown body to at least 800° C., such as to at least 1000° C., such as to at least 1250° C. The sintering step may comprise heating the green body and/or brown body to up to 2000° C., such as up to 1800° C., such as up to 1650° C. The sintering step may comprise heating the green body and/or brown body to from 800 to 2000° C., such as from 1000 to 1800° C., such as from 1250 to 1650° C.

The sintering step may comprise partial sintering of the green body and/or brown body such that designed pore size produced by the in-situ formation of nano- and/or micro-particles is maintained and/or further refined to the desired end pore size of the membrane.

The 3D printed green body may not require sintering to form a membrane. The 3D printed green body may not require heating to form a membrane. The 3D printed green body may be a membrane.

The membrane may be a ceramic membrane, wherein the powder in the additive manufacturing processes disclosed herein may be a ceramic powder.

The ceramic powder may be any suitable ceramic powder used in additive manufacturing.

The ceramic powder may comprise alumina, aluminum nitride, aluminum oxide, barium titanate, beta-tricalcium phosphate, biological ceramics, bismuth, boron carbide, carbides, hydroxyapatite, iron oxide, magnesium silicates, nitrides, oxides, silicon aluminum, silica, silicon carbide, silicon dioxide, silicon nitride, titanate, titanium dioxide, yttrium carbonate, YSZ (yttria stabilised zirconia), zinc oxide, zirconate, zirconia or zirconium, or a mixture thereof.

The ceramic powder may comprise a mixture of different ceramic powder compositions. The ceramic powder may comprise a first ceramic powder fraction and a second ceramic powder fraction.

The ceramic powder may have a volume mean average size of at least 1 nm, such as at least 10 nm. The ceramic powder may have a volume mean average size of up to 100 μm, such as up to 10 μm. The ceramic powder may have a volume mean average size of from 1 nm to 100 μm, such as from 10 nm to 10 μm. The ceramic powder may have a volume mean average size of from 1 nm to 10 μm.

The ceramic powder may comprise a coarse ceramic powder fraction. A coarse ceramic powder fraction may be defined as a ceramic powder with a micron size particle (i.e. a volume mean average particle size of at least 0.1 μm). A coarse ceramic powder fraction may have a D10 particle size of at least 0.1 μm.

The ceramic powder may comprise a fine ceramic powder fraction. A fine ceramic powder fraction may be defined as a ceramic powder with a nano size particle (i.e. a volume mean average particle size of less than 0.1 μm). A fine ceramic powder fraction may have a D90 particle size of up to 0.1 μm.

The ceramic powder may comprise a mixture of a first ceramic powder fraction, such as a coarse ceramic powder fraction, and a second ceramic powder fraction, such as a fine ceramic powder fraction. The volume ratio of the first ceramic powder fraction to the second ceramic powder ratio, such as the volume ratio of the coarse ceramic powder fraction to fine ceramic powder fraction, may be at least 1:20, such as at least 1:15, such as at least 1:10, such as at least 1:5, such as at least 1:2. The volume ratio of coarse ceramic powder fraction to fine ceramic powder fraction may be up to 20:1, such as up to 15:1, such as up to 10:1, such as up to 5:1, such as up to 2:1.

The volume ratio of coarse ceramic powder fraction to fine ceramic powder fraction may be from 20:1 to 1:20, such as from 15:1 to 1:15, such as from 10:1 to 1:10, such as from 5:1 to 1:5, such as from 1:2 to 2:1. The volume ratio of coarse ceramic powder fraction to fine ceramic powder fraction may be from 1:1 to 20:1, such as from 1:1 to 10:1, such as from 5:1 to 10:1, or such as from 2:1 to 10:1.

The ceramic powder may comprise a free-flowing ceramic material. Suitably, the ceramic powder may be free flowing. Flowability is the ability of a powder to flow freely which may help with uniform powder spreading and thus homogeneous green body and sintered part structure. The flowability of the ceramic powder may increase with a higher ratio of coarse to fine powders.

The volume mean average particle size and particle size distributions of the ceramic powders may be measured by dynamic light scattering technique (DLS) and is at least suitable for particles sizes from 0.3 nm to 10 μm.

The volume mean average particle size and particle size distributions of the ceramic powders may be measured by laser light scattering technique (also known as laser diffraction analysis) and is at least suitable for particle sized from >10 μm to 3.5 mm. The Mastersizer 3000 by Malvern Panalytical may be used for laser light scattering.

The ceramic powder may comprise a ceramic powder fraction having a generally spherical particle shape.

The ceramic powder may comprise a ceramic powder fraction with a generally non-spherical particle shape. The ceramic powder fraction having a non-spherical particle shape may be selected from particles with a cylindrical, angular, spongey, acicular, flakey, cubic, and/or an aggregated shape.

The ceramic powder may comprise a ceramic powder fraction having a generally spherical particle shape and ceramic powder fraction having generally non-spherical particle shape.

The ceramic powder may comprise a mixture of a first ceramic powder fraction with a generally spherical shape and a second ceramic powder fraction with a cylindrical, spongey, angular, acicular, flakey, cubic, and/or an aggregated shape. The ceramic powder may comprise a mixture of a first ceramic powder fraction with a generally spherical shape and a second ceramic powder fraction with a cylindrical, angular and/or an acicular shape.

The particle shape of the ceramic powder may be measured by Transmission Electron Microscopy (TEM) which provide direct measurement of powders with a particle size range from 0.1 nm to 5 μm. The particle shape of the ceramic powder may be measured by Raman spectroscopy. The Morphologi 4 by Malvern Panalytical may be used to determine the particle shape of the ceramic powder using Raman spectroscopy with a particle size range of from >5 μm to over 1,300 μm.

The ceramic powder may have a press density of at least 0.5 g/cm³, such as at least 1 g/cm³, such as at least 2 g/cm³. The ceramic powder may have a press density of up to 10 g/cm³, such as up to 8 g/cm³, such as up to 6 g/cm³. The ceramic powder may have a press density from 0.5 to 10 g/cm³, such as from 1 to 8 g/cm³, such as from 2 to 6 g/cm³. The press density is the density of the ceramic powder prior to sintering and/or the press density is the density of the ceramic powder and binder in the form of the 3D printed green body. The press density of the ceramic powder may be equivalent to the bulk density of the 3D printed green body. The press density may be measured using mercury porosimetry.

The ceramic powder may have a fired density of at least 0.5 g/cm³, such as at least 1 g/cm³, such as at least 2 g/cm³. The ceramic powder may have a fired density of up to 10 g/cm³, such as up to 8 g/cm³, such as up to 6 g/cm³. The ceramic powder may have a fired density from 0.5 to 10 g/cm³, such as from 1 to 8 g/cm³, such as from 2 to 6 g/cm³. The fired density is the density of the ceramic powder after sintering, in which at least some of the binder has been removed. The fired density may be measured using mercury porosimetry or by the Archimedes' principle.

The binder may disperse into the inter-particle spaces between the ceramic particles. The binder may diffuse into the inter-particle spaces between the ceramic particles.

The binder may be dispersed as a binder composition.

The binder may comprise a metallic binder, a ceramic binder and/or a polymeric binder.

A polymeric binder may comprise acrylate, methacrylate, acrylate polymer (for example a polyacrylate), methacrylate polymers (for example a poly(meth)acrylate), polyvinyl alcohol, polyethylene glycol, polyvinylpyrrolidone, carbohydrates (for example, dextrin, maltodextrin, starch), or a combination thereof.

A polymeric binder may comprise a binder selected from polyacrylate, poly(meth)acrylate and/or polyethylene glycol.

The binder may comprise phosphoric acid, colloidal silica, or a combination thereof.

The binder composition may further comprise a rheology modifier selected from the group comprising clays, organoclays, organic thixotropes, acrylics, hydrophobically modified polyurethane, polyether polyol. The binder composition may further comprise a suitable solvent, such as water or an alcohol, for example, methanol, ethanol, propanol.

The binder composition may have a viscosity of at least 1 cP, such as at least 4 cP. The binder composition may have a viscosity of up to 10 cP, such as up to 7 cP. The binder composition may have a viscosity of from 1 cP to 10 cP, such as from 4 cP to 7 cP. The viscosity of the binder composition may be measured according any suitable method known to the skilled person. For example, the viscosity of the binder composition may be measured using a capillary viscometer. The viscosity as used herein is understood to mean absolute viscosity.

The binder composition may have a density of at least 0.5 gcm⁻³, such as at least 0.9 gcm⁻³. The binder may have a density of up to 2 gcm⁻³, such as up to 1.2 gcm⁻³. The binder composition may have a density of from 0.5 gcm⁻³ to 2 gcm⁻³, such as from 0.9 gcm⁻³ to 1.2 gcm⁻³.

The binder composition may have a surface tension of at least 10 dynes/cm, such as at least 20 dynes/cm. The binder composition may have a surface tension of up to 80 dynes/cm, such as up to 50 dynes/cm. The binder composition may have a surface tension of from 10 dynes/cm to 80 dynes/cm, such as from 20 dynes/cm to 50 dynes/cm. The surface tension of the binder composition may be measured according to any suitable method known to the skilled person. For example, the surface tension of the binder composition may be measured using a force tensiometer.

The binder composition may further comprise additive particles. The binder composition may further comprise additive particles selected from ceramic particles, metallic particles, polymeric particles, mixed metal particles, metal oxide particles and/or non-metal oxide particles. The binder composition may further comprise additive particles selected from ceramic particles, metal oxide particles, and/or non-metal particles, such as, ceramic particles and/or metal oxide particles. The binder composition may further comprise ceramic particles.

The additive particles may be ceramic additive particles. The ceramic additive particles may be formed of a ceramic selected from one or more of alumina, aluminum nitride, aluminum oxide, barium titanate, beta-tricalcium phosphate, biological ceramics, bismuth, boron carbide, carbides, hydroxyapatite, iron oxide, magnesium silicates, nitrides, oxides, silicon aluminum, silica, silicon carbide, silicon dioxide, silicon nitride, titanate, titanium dioxide, yttrium carbonate, YSZ (yttria stabilised zirconia), zinc oxide, zirconate, zirconia and zirconium, or a mixture thereof.

The additive particles may have an average particle size from 0.1 nm to 100 μm. The additive particles may have a particle size distribution wherein the D50 particle size is from 0.1 nm to 100 μm.

The additive particles may be microparticles and/or nanoparticles.

The additive microparticles may have an average particle size from 0.1 μm to 100 μm, such as from 0.1 μm to 20 μm, or from 0.1 μm to 5 μm. The additive microparticles may have a particle size distribution wherein the D50 particle size is from 0.1 μm to 100 μm, such as from 0.1 μm to 20 μm, or from 0.1 μm to 5 μm. The additive microparticles may have a particle size distribution wherein the D10 particle size at least 0.1 μm, and/or the D90 particle size up to 100 μm, such as up to 20 μm, or up to 5 μm.

The additive nanoparticles may have an average particle size of from 0.1 nm to 100 nm, such as from 1 nm to 50 nm, or from 2 nm to 10 nm. The additive nanoparticles may have a particle size distribution wherein the D50 particle size is from 0.1 nm to 100 nm, such as from 1 nm to 50 nm, or from 2 nm to 10 nm. The additive nanoparticles may have a particle size distribution wherein the D10 particle size at least 0.1 nm, and/or the D90 particle size is up to 100 nm, such as up to 50 nm, or up to 10 nm.

The binder composition may comprise a mixture of additive microparticles and additive nanoparticles. The binder composition may comprise a mixture of additive microparticles and additive nanoparticles, wherein the volume ratio of microparticles to nanoparticles may be at least 1:20, such as at least 1:15, such as at least 1:10, such as at least 1:5, such as at least 1:2. The volume ratio of microparticles to nanoparticles may be up to 20:1, such as up to 15:1, such as up to 10:1, such as up to 5:1, such as up to 2:1.

The volume ratio of microparticles to nanoparticles may be from 20:1 to 1:20, such as from 15:1 to 1:15, such as from 10:1 to 1:10, such as from 5:1 to 1:5, such as from 1:2 to 2:1. The volume ratio of microparticles to nanoparticles may be from 1:1 to 20:1, such as from 1:1 to 10:1, such as from 5:1 to 10:1, or such as from 2:1 to 10:1.

The particle size and particle size distribution of the additive particles, suitably the additive microparticles and/or additive nanoparticles may be measured by Transmission Electron Microscopy (TEM) for a particle size range from 0.1 nm to 5 μm. Dynamic light scattering technique (DLS) may be used to measure particles sizes from >5 μm to 20 μm.

The additive particles of the binder composition may be incorporated into the 3D printed green body and may remain in the ceramic membrane even after any post-processing is carried out on the 3D printed green body. Accordingly, the additive particles of the binder composition may be incorporated into the ceramic membrane.

The nano- and/or micro-particles may be formed in-situ during the additive manufacturing process from nano- and/or micro-particle precursors. The nano- and/or micro-particles may be formed in-situ during a post processing step of the 3D printed green body from nano- and/or micro-particle precursors.

It is understood that the term “in-situ” as used herein relates to the formation of the nano- and/or micro-particle during the additive manufacturing process, and/or during a post processing step of the 3D printed green body. The nano- and/or micro-particles may be formed in-situ from one or more precursor compounds.

It is understood that the term “formed” as used herein with respect to the in situ formed nano- and/or micro-particles relates to any suitable chemical or physical change that converts the nano- and/or micro-particle precursors to the final form of the nano- and/or micro-particles. The term “formed in-situ” may relate to the changing of the nano- and/or micro-particle precursors from a first form to a second form, during the additive manufacturing process, and/or during a post processing step of the 3D printed green body. The change may comprise the formation, and/or breaking, of covalent and/or ionic bonds. The change may comprise the partial loss of a part of the precursor(s) of the nano- and/or micro-particle.

A nano- and/or micro-particle precursor may comprise any suitable reagent, or mixture of reagents, that are capable to form a nano- and/or micro-particle during the additive manufacturing process, and/or during a post processing step of the 3D printed green body.

The nano- and/or micro-particle may be formed by heating the nano- and/or micro-particle precursor. The nano- and/or micro-particle may be formed by heating the nano- and/or micro-particle precursor to at least 100° C., such as at least 300° C., such as at least 500° C. The nano- and/or micro-particle may be formed by heating the nano- and/or micro-particle precursor to up to 1500° C., such as up to 1250° C., such as up to 800° C.

The nano- and/or micro-particle may be formed by heating the nano- and/or micro-particle precursor from 100 to 1500° C., such as at from 300 to 1250° C., such as from 500 to 800° C.

It will be apparent that the nano- and/or micro-particle precursors may themselves be of nano- and/or micro-particle size. The nano- and/or micro-particle precursors may reduce in size upon formation of the nano- and/or micro-particles in situ, thereby helping to provide a controlled pore size in the membrane.

The nano- and/or micro-particle may be formed in-situ via a partially sacrificial nano- and/or micro-particle precursor. The nano- and/or micro-particle precursor may be a partially sacrificial nano- and/or micro-particle.

A partially sacrificial nano- and/or micro particle precursor may comprise a sacrificial component and a non-sacrificial component. The sacrificial component may be removed during the additive manufacturing printing process to form the green body of the ceramic membrane, and/or in a post processing step of the 3D printed green body. The non-sacrificial component is retained in the ceramic membrane. The non-sacrificial component may form the nano- and/or micro-particles in the pores of the ceramic membrane. The sacrificial component may be removed by any suitable method known to the skilled person. For example, the sacrificial component may be removed by dissolution or decomposition. The sacrificial component may be removed by thermal decomposition.

A partially sacrificial nano- and/or micro-particle precursor comprises a sacrificial component that may be partially sacrificed, typically, partially sacrificed in-situ, such as during the additive manufacturing process and/or during a post processing step of the 3D printed green body. A partially sacrificial nano- and/or micro-particle may be at least partially retained in the final ceramic membrane. In contrast, a sacrificial compound may be substantially completely removed in a post-processing step.

Advantageously, the removal of the sacrificial component of the partially sacrificial nano- and/or micro-particle may result in the formation of controllable pore sizes and pore size distribution between the in situ nano- and/or microparticles.

The nano- and/or micro-particle may comprise a metal-silica nano- and/or micro-particle; a metal oxide nano- and/or micro-particle; a mixed metal oxide nano- and/or micro-particle; a non-metal oxide nano- and/or micro-particle; and/or a metal nano- and/or micro-particle. The nano- and/or micro-particle may comprise a metal oxide nano- and/or micro-particle; a silicon oxide nano- and/or micro-particle and/or a metal-silicon oxide nano- and/or micro-particle. The nano- and/or micro-particle may comprise a metal oxide nano- and/or micro-particle.

The metal-silica nano- and/or micro-particle may comprise a nickel-silica, silver-silica, platinum-silica, and/or an iron-silica nano- and/or micro-particle.

The metal-silica nano- and/or micro-particle may be obtainable from an in-situ reaction between a polysilazane and a metal complex.

The metal complex may comprise a metal salt. The metal complex may comprise a metal acetate, metal chloride, metal oxide, metal hydroxide, metal isopropoxide and/or metal cyclopentadiene. The metal of the metal complex may be selected from nickel, zinc, manganese, cobalt, platinum, iron, nickel, magnesium, chromium and/or titanium.

The metal complex may be selected from a nickel acetate, zinc acetate, manganese acetate, cobalt acetate, platinum chloride, iron cyclopentadiene, nickel cyclopentadiene, magnesium oxide, chromium oxide, chromium hydroxide, and/or titanium isopropoxide.

The metal-silica nano- and/or micro-particle may be obtainable from an in-situ reaction between a polysilazane and a metal complex at a temperature of at least 100° C., such as at least 200° C., such as at least 300° C., such as at least 400° C., such as at least 500° C., such as at least 600° C., for example, at about 700° C.

The metal oxide nano- and/or micro-particle may comprise an aluminium oxide, magnesium oxide, titanium dioxide, magnesium oxide, copper oxide, and/or an iron oxide nano- and/or micro-particle.

The metal oxide nano- and/or micro-particle may be obtainable from the hydrolysis and condensation reaction of a metal alkoxide, such as a metal isopropoxide. The aluminium oxide nano- and/or micro-particle may be obtainable from the hydrolysis and condensation reaction of an aluminium alkoxide. The aluminium alkoxide may be selected from an aluminium isopropoxide.

The aluminium oxide nano- and/or micro-particle may be obtainable from in-situ reaction of an alumoxane oxide nano- and/or micro-particle, such as a carboxylate-alumoxane nano- and/or micro-particle. Accordingly, an alumoxane oxide nano- and/or micro-particle may be a partially sacrificial nano- and/or micro-particle

The alumoxane nano- and/or micro-particle may be obtainable from the reaction between a boehmite and a carboxylic acid-containing compound.

The carboxylic acid-containing compound may comprise an optionally functionalised aliphatic group. The optionally functionalised aliphatic group may comprise at least 1 carbon atom, such as at least 5 carbon atoms, such as at least 10 carbon atoms, such as at least 20 carbon atoms in the aliphatic chain. The optionally functionalised aliphatic group may comprise from 1 to 50 carbon atoms, such as from 2 to 30 carbon atoms, such as from 3 to 10 carbon atoms in the aliphatic chain.

The titanium dioxide nano- and/or micro-particle may be obtainable from the thermal decomposition of titanium alkoxide. The titanium dioxide nano- and/or micro-particle may be obtainable by the hydrolysis and condensation of a titanium alkoxide.

The titanium alkoxide may be selected from titanium isopropoxide.

The magnesium oxide nano- and/or micro-particle may be obtainable from magnesium nitrate under basic conditions.

The copper oxide nano- and/or micro-particle may be obtainable from acidic decomposition of copper acetate.

The iron oxide nano- and/or micro-particle may be obtainable from hydrothermal oxidation of mixed iron (II) and iron (III) hydroxides. The iron oxide nano- and/or micro-particle may be obtainable from thermal decomposition of iron complexes such as iron carbonyl or iron acetylacetonate.

The nano- and/or micro-particle may comprise a mixed metal oxide nano- and/or micro-particle.

The mixed metal oxide nano- and/or micro-particle may be obtainable from reaction between a transition metal salt, a rare earth metal salt and an organic acid. The mixed metal oxide nano- and/or micro-particle may comprise a perovskite nano- and/or micro-particle. The mixed metal oxide nano- and/or micro-particle may be obtainable from reaction between a transition metal salt, a rare earth metal salt and an organic acid carried out at at least 150° C., such as at least 350° C., such as at least 500° C., such as at least 750° C., such as at least 1000° C. or such as at least 1250° C. The transition metal salt and/or the rare earth metal salt may comprise a metal nitrate and/or hydrate.

The nano- and/or micro-particle may comprise a non-metal oxide nano- and/or micro-particle. The non-metal oxide nano- and/or micro-particle may comprise a silica nano- and/or micro-particle. The silica nano- and/or micro-particle may be obtainable from any suitable silica nano- and/or micro-particle precursor known to the skilled person. The silica nano- and/or micro-particle may be obtainable by the hydrolysis and condensation of a silica alkoxide.

A suitable silica nano- and/or micro-particle precursor may comprise an organosilicon compound. The organosilicon compound may comprise an organosilane such as vinyltriethoxysilane, 1,2-Dimethoxy-1,1,2,2-tetramethyldisilane and/or trimethyoxyphenylsilane. The silica nano- and/or micro-particle precursor may comprise (m)ethoxysilane, silicon hydride and/or silicon tetraacetate.

The nano- and/or micro-particle may comprise a metal nano- and/or micro-particle. A suitable metal nano- and/or micro-particle precursor may comprise a metal acetate complex, metal acetylacetonate complex and/or a metal cyclopentadienyl complex.

The metal nano- and/or micro-particle may comprise a silver nano- and/or micro-particle. A suitable silver nano- and/or micro-particle precursor may comprise a silver salt and a reducing agents, for example, silver nitrate and sodium borohydride.

The membrane may comprise a pore, wherein a nano- and/or microparticle, or residue thereof is arranged within a pore of the membrane. The membrane may comprise a nanoparticle, or residue thereof wherein the nanoparticle, or residue thereof is arranged within the pores of membrane. The membrane may comprise a nano- and/or micro-particle formed in-situ during the additive manufacturing process and/or a post-processing step, and wherein the in-situ formed nano- and/or micro-particle, or residue thereof, is arranged within the pores of the membrane.

The presence of the nano- and/or micro-particles in the pores of the ceramic member may provide a smaller inter particle pore size than would have been produced in the absence of such nano- and/or micro-particles. In the presence of the nano- and/or micro-particles, the porous ceramic material may comprise a higher number of nano-inter particle pore sizes. In the absence of the nano- and/or micro-particles, the ceramic material may comprise a higher number of micro-inter particle pore sizes.

The membrane may comprise a coating. The coating may be operable to provide a separation effect. As such, the coating may be operable to selectively promote passage of some of the material to be separated while reducing passage of other material.

The coating may comprise a hydrophilic agent and/or a superhydrophilic agent. The coating may comprise a first coating layer comprising a hydrophilic agent and a second coating layer comprising a superhydrophilic agent. The second coating layer may be arranged over at least a part of the first coating layer.

The coating comprising a superhydrophilic agent may be arranged on the surface of the membrane that faces the feed flow.

The coating may be at least partially crosslinked and comprise a superhydrophilic agent.

The coating may be formed from a coating composition, such as a coating comprising a hydrophilic agent and/or a superhydrophilic agent, and/or being at least partially crosslinked and comprising a superhydrophilic agent may be formed from a coating composition comprising the hydrophilic agent or precursor thereof, when present, and/or the superhydrophilic agent or precursor thereof.

The surface of the membrane operable to receive a coating may be hydrophilic. The contact angle of water on the substrate surface may be ≤65°, such as ≤60° and preferably ≤555°.

The membrane may be a pre-treated. The membrane may be treated prior to the addition of the coating formulations. For example, a surface of the membrane may have been subjected to hydrophilisation to form a hydrophilic surface. Said substrate treatment may comprise the addition, suitably the grafting, of functional groups and/or the addition of hydrophilic additives. The added functional groups may be selected from one or more of hydroxyl, ketone, aldehyde, carboxylic acid and amine groups. Preferably hydroxyl or carboxylic acid groups.

The grafting of functional groups may be achieved by plasma treatment, corona discharge, redox reaction, radiation, UV-ozone treatment, and/or chemical treatment. One example of plasma treatment is using an oxygen plasma on the substrate for thirty seconds.

The functionalised groups of the membrane may be operable to interact with a functional group of the adjacent coating layer, such as with physical and/or chemical bonding. For example, grafted hydroxyl groups introduced by plasma treatment may be operable to react with carboxylated hydrophilic cellulosic materials in a coating layer via esterification or react with a siloxane component in an intermediate layer.

Additionally, or alternatively, surface treatment may be achieved by incorporating hydrophilic materials into membrane. As such, the membrane may comprise hydrophilic material.

The hydrophilic material that may be incorporated in to the membrane may comprise cellulose acetate, quaternized polyethersulfone, polylactic acid, polyethylenimine, polyetherimide, polyvinylpyrrolidone and/or poly(vinyl alcohol).

The hydrophilic material may be incorporated into the powder and/or binder such that it is incorporated into the 3D printed green body of the membrane.

The membrane may comprise ≥1% hydrophilic material by weight of the membrane, such as ≥5 wt %, or ≥7 wt %. The membrane may comprise ≤50% hydrophilic material by weight of the substrate, such as ≤35 wt %, or ≥25 wt %. The membrane may comprise from 1 to 50% hydrophilic material by weight of the substrate, such as from 5 to 35 wt %, or from 7 to 25 wt %.

Advantageously, surface treatment may provide improved adhesion and uniformity of the subsequent coating layers applied on the membrane. The presence of said hydrophilicity and/or functionality on the membrane may provide a coating layer having a more robust mechanical integrity, a more uniform structure and improved continuity. The said hydrophilicity and/or functionality may also provide improved life span and/or stability. Surface treatment can also improve properties such as enhanced permeability.

The hydrophilic agent may be a material having a surface tension that is lower than the surface energy of the substrate.

The hydrophilic agent, and/or coating layer comprising the hydrophilic agent, may have a contact angle of ≤65°, such as ≤60°, or ≤55°, such as ≤50°.

The hydrophilic agent, and/or coating layer comprising the hydrophilic agent, suitably has a higher contact angle than the superhydrophilic agent, or the coating layer comprising the superhydrophilic agent.

The hydrophilic agent or precursor thereof may comprise a (co)polymer or oligomer, such as a polyelectrolyte, polydopamine, and/or polyethylenimine, or precursor thereof.

The hydrophilic agent (co)polymer may be branched.

The hydrophilic agent (co)polymer may have a weight average molecular weight (Mw) of at least 5,000 Da, such as at least 10,000 Da or at least 15,000 Da. The hydrophilic agent (co)polymer may have a weight average molecular weight (Mw) of up to 50,000 Da, such as up to 40,000 Da or up to 30,000 Da. The hydrophilic agent (co)polymer may have a weight average molecular weight (Mw) of from 5,000 to 50,000 Da, such as from 10,000 to 40,000 Da or from 15,000 to 30,000 Da.

The hydrophilic agent (co)polymer may be formed from vinylpyrrolidone, vinyl alcohol, allylamine, ethylenimine, allylammonium chloride, vinylamine, lysine, chitosan, silane-based and/or its derivatives; acrylics, such as water soluble acrylics; acrylamide (e.g., copolymers containing 2-acrylamido-2-methylpropane sulfonic acid-AMPS); and/or hydroxyalkylmethacrylate, such as hydroxyethylmethacrylate (e.g. poly HEMA), and copolymers thereof, such as with acrylic acid, methacrylic acid, and/or 2-acrylamido-2-methylpropane sulfonic acid.

The hydrophilic polymer may be a copolymer formed from acrylamide and acrylic acid monomers with polyallylammonium chloride.

The hydrophilic agent may comprise a two-dimensional material and/or a nanoparticle material.

The hydrophilic agent may comprise a graphene-based material, metal organic framework material, silicene, germanene, stanene, boron-nitride, suitably h-boron nitride, carbon nitride, metal-organic nanosheets, molybdenum disulfide, tungsten disulfide, polymer/graphene aerogel, and/or positively charged polymers.

The graphene-based material may comprise graphene oxide, reduced graphene oxide, hydrated graphene, amino-based graphene, alkylamine functionalised graphene oxide, ammonia functionalised graphene oxide, amine functionalised reduced graphene oxide, octadecylamine functionalised reduced graphene oxide, and/or polymer graphene aerogel, preferably graphene oxide.

The hydrophilic agent may have an average platelet size of from 1 nm to 100,000 nm, such as from 10 nm to 50,000 nm, or from 100 nm to 15,000 nm, preferably from 500 nm to 14,000 nm.

The hydrophilic agent may have a platelet size distribution D50 of from 1 nm to 15,000 nm, preferably from 100 nm to 14,000 nm. The graphene-based material may have a platelet size distribution D90 of from 5 nm to 15,000 nm, preferably from 100 nm to 14,000 nm.

The hydrophilic agent may have an oxygen atomic content of from 1% to 70%, such as from 5% to 60%, or from 10% to 50%, preferably from 15% to 55%.

Suitably, the hydrophilic agent, preferably graphene-based material such as graphene oxide, comprises hydroxyl, carboxylic and/or epoxide groups. The oxygen content of the hydrophilic agent, preferably with functional groups of hydroxyl and/or carboxylic groups, may be up to 60% oxygen atomic percentage, such as up to 50% or up to 45% oxygen atomic percentage. Suitably, the oxygen content is from 20 to 25% or from 25 to 45%. Advantageously, when the oxygen content is from 25 to 45% a surfactant may not be required to maintain stability of the coating composition. Preferably, the oxygen content is from 25 to 40% oxygen atomic percentage. Such a range can provide improved stability of the coating composition despite the absence of other stabilising components such as surfactants, and provide enhanced interaction with a primer layer. Oxygen content may be characterised by X-ray photoelectron spectroscopy (XPS), K-Alpha grade, from ThermoFisher Scientific.

The oxygen content of the hydrophilic agent may be up to 50% oxygen atomic percentage.

The oxygen content of the hydrophilic agent may be from 25 to 45%.

The size distribution of the hydrophilic agent may be such that at least 30 wt % of the material have a diameter of between 1 nm to 5,000 nm, such as between 1 to 750 nm, 100 to 500 nm, 100 to 400 nm, 500 to 1000 nm, 1000 to 3000 nm, 1000 to 5000 nm, 1500 to 2500 nm, or 500 to 1500 nm, preferably 100 to 3000 nm, more preferably at least 40 wt %, 50 wt %, 60 wt %, 70 wt % and most preferably at least 80 wt % or at least 90 wt % or 95 wt % or 98 wt % or 99 wt %. The size of the hydrophilic agent and size distribution may be measured using transmission electron microscopy (TEM, JEM-2100F, JEOL Ltd. Japan).

The hydrophilic agent may be in the form of a monolayer or multi-layered particle, preferably a monolayer. The particles of hydrophilic agent may be formed of single, two or few layers of hydrophilic agent, wherein few may be defined as between 3 and 20 layers. Suitably, the hydrophilic agent may comprise from 1 to 15 layers, such as from 2 to 10 layers or 5 to 15 layers. Suitably, at least 30 wt % of the hydrophilic agent comprise from 1 to 15 layers, such as from 1 to 10 layers or 5 to 15 layers, more preferably at least 40 wt %, 50 wt %, 60 wt %, 70 wt % and most preferably at least 80 wt % or at least 90 wt % or 95 wt % or 98 wt % or 99 wt %. The number of layers in the hydrophilic agent may be measured using atomic force microscopy (AFM or transmission electron microscopy (TEM)) (TT-AFM, AFM workshop Co., CA, USA).

Suitably, the d-spacing between adjacent lattice planes in the hydrophilic agent or mixture thereof is from 0.34 nm to 5000 nm, such as from 0.34 nm to 1000 nm, or from 0.4 to 500 nm, or from 0.4 to 250 nm, such as from 0.4 to 200 nm, or from 0.4 to 150 nm, or from 0.4 to 100 nm, or from 0.4 to 50 nm, or from 0.4 to 25 nm, or from 0.4 to 10 nm, or from 0.4 to 8 nm, such as from 0.4 to 7 nm, from 0.45 to 6 nm, 0.50 to 5 nm, or 0.55 to 4 nm, or 0.6 to 3 nm, for example 0.6 to 2.5 nm, 0.6 to 1 nm, 0.6 to 2 nm, or 0.6 to 1.5 nm.

The water contact angle of the superhydrophilic agent, the coating layer, or coating composition, suitably the water contact angle of the second coating layer comprising the superhydrophilic agent, may be ≤25°, such as ≤20°, such as ≤15°, preferably ≤10°. When used herein, the water contact angle was measured according to ASTM D7334-08.

The water contact angle of the superhydrophilic agent, or the coating layer, suitably the water contact angle of the second coating layer comprising the superhydrophilic agent, may be ≤20°.

The superhydrophilic agent may comprise a (co)polymer or oligomer, such as a polymer electrolyte, or precursor thereof.

The superhydrophilic (co)polymer and/or hydrophilic (co)polymer may comprise a hydrogel, or be operable to form a hydrogel upon contact with water.

The superhydrophilic agent (co)polymer may be formed from monomers including a vinyl monomer, such as styrene sulfonate salt, vinyl ether (such as methyl vinyl ether), N-vinyl-2-pyrrolidone (NVP), vinyl acetate (VAc); a silane-based monomer and/or its derivatives; an acrylic monomer, such as a (hetero)aliphatic (alk)acrylate, acrylic acids and salts thereof, bisphenol acrylics, fluorinated acrylate, methacrylate, polyfunctional acrylate, hydroxyethoxyethyl methacrylate (HEEMA), hydroxydiethoxyethylmethacrylate (HDEEMA), methoxyethyl methacrylate (MEMA), methoxyethoxyethyl methacrylate (MEEMA), methoxydiethoxyethyl methacrylate (MDEEMA), ethylene glycol dimethacrylate (EGDMA), acrylic acid (AA), PEG acrylate (PEGA), PEG methacrylate (PEGMA), PEG diacrylate (PEGDA), PEG dimethacrylate (PEGDMA), bis(trimethylsilyloxy)methylsilylpropyl glycerol methacrylate (SiMA), methacryloyloxyethyl phosphorylcholine (MPC), 6-acetylthiohexyl methacrylate, acrylic anhydride, [2-(acryloyloxy)ethyl]trimethylammonium chloride, 2-(4-benzoyl-3-hydroxyphenoxy)ethyl acrylate, benzyl acrylate, or their trimethacrylate, dimethacrylate tri-block derivatives; thiol functionalised acrylate monomers, such as thiol functionalised (meth)acrylate; acryloyl chloride; acrylonitrile; maleimide; an acrylamide based monomer, such as acrylamide, methacrylamide; N,N-dimethylacrylamide (DMA), 2-acrylamido-2-methylpropane sulfonic acid, N-isopropyl AAm (NIPAAm), N-(2-hydroxypropyl) methacrylamide (HPMA), 4-acryloylmorpholine; carbohydrate monomer; a polyacid and/or polyol, such as maleic acid (such as maleic acid with a vinyl ether (e.g., Gantrez, partially neutralised with sodium)), ethylene glycol (EG); gelatin methacryloyl; and/or methacrylated hyaluronic acid, optionally with crosslinkers such as epichlorohydrin (ECH), N,N′-methylene-bis-acrylamide (BIS) and/or divinyl sulfone (DVS).

A superhydrophilic agent (co)polymer may have a molecular weight (Mw) of ≥2,000 g/mol, such as ≥4,000 g/mol, or ≥6,000 g/mol. For example, up to ≤30,000 g/mol, such as up to ≤20,000 g/mol, or up to ≤15,000 g/mol. For example, from 2,000 to 30,000 g/mol, such as from 4,000 to 20,000 g/mol, or from 6,000 to 15,000 g/mol.

The superhydrophilic agent (co)polymer may have a molecular weight (Mw) of ≥6,000 g/mol.

The superhydrophilic agent (co)polymer may have a molecular weight (Mw) of from 2,000 to 30,000 g/mol.

The coating or coating composition may comprise a film former, such as a linear and/or hydrophilic polymer (e.g. PVP etc). A film former may be selected from a polysaccharide or derivative thereof, such as cellulose or a derivative thereof, for example methylcellulose, hydroxyethyl cellulose, hydroxypropyl cellulose, hydroxypropyl methylcellulose, cellulose acetate phthalate, hydroxypropyl methylcellulose phthalate, carboxymethyl ethylcellulose, hydroxypropyl methylcellulose acetate succinate, ethylcellulose, sodium alginate; acrylic (co)polymers; vinyl (co)polymer, such as polyvinyl pyrrolidone; polyvinyl alcohol, polyvinyl acetate phthalate; polyethylene glycol, polyethyleneimine (PEI); and/or poly(ethylene) oxide. Preferably, the film former comprises a water-soluble film former, such as hydroxypropyl methylcellulose acetate succinate.

The amount of film former in the coating composition may be 510 wt % by dry weight of the coating composition, such as ≤5 wt %, such as ≤4 wt %, ≤3.5 wt %, ≤3 wt %, ≤2.5 wt %, preferably ≤2 wt %.

The hydrophilic agent, superhydrophilic agent, or precursors thereof, coating layer and/or film former, when present, may be at least partially crosslinked, or be operable to be at least partially crosslinked. The hydrophilic agent, superhydrophilic agent, or precursors thereof, film former and/or coating layer may be at least partially crosslinked by using an additive crosslinker. As such, the coating composition comprising the hydrophilic agent, superhydrophilic agent and/or film former may further comprise an additive crosslinker. The hydrophilic agent, superhydrophilic agent, or precursors thereof, coating layer and/or film former, may be at least partially self-crosslinked, or be operable to be self-crosslinked prior.

The hydrophilic, superhydrophilic (co)polymer, or precursors thereof, and/or film former (co)polymer, when present, may be formed from a crosslinker or residue thereof, suitably in an amount of ≥0.5% by weight of the total monomers of the (co)polymer, or ≥0.8 wt % or ≥1 wt %. For example, up to ≤15% by weight of the total monomers of the (co)polymer, up to ≤10 wt % or up to ≤5 wt %. For example, from 0.5 to 15% by weight of the total monomers of the (co)polymer, or from 0.8 to 10 wt % or from 1 to 5 wt %.

The coating composition may comprise a crosslinker in an amount of ≥0.5% by dry weight the composition, such as ≥0.8 wt % or ≥1 wt %. For example, up to ≤15% by dry weight the composition, such as up to ≤10 wt % or up to ≤5 wt %. For example, from 0.5 to 15% by by dry weight the composition, such as from 0.8 to 10 wt % or from 1 to 5 wt %.

The superhydrophilic (co)polymer may be formed from a crosslinker in an amount of ≥0.5% by weight of the total monomers of the (co)polymer.

The hydrophilic, superhydrophilic (co)polymer, or precursors thereof, and/or film former (co)polymer, when present, may be formed from a crosslinker or residue thereof, suitably in an amount of from 0.5 to 15% by weight of the total monomers of the (co)polymer.

The crosslinker may be a multi-functional acrylic or vinyl monomer, a divalent metal ion, multi-functional carbodiimide, multi-functional aziridine, silane; multi-functional epoxide and/or multi-functional isocyanate, or residue thereof.

The crosslinker may comprise tetramethylethylenediamine, methylene_bis-acrylamide, ethylene glycol_dimethacrylate, polyethylene glycol dimenthacrylate, triethylene glycol dimethacrylate N-isopropylacrylamide; N,N-diethylacylamide, epichlorohydrin (ECH), N,N′-methylene-bis-acrylamide (BIS), divinyl sulfone (DVS), citric acid, dicysteine peptides, dithiothreitol (DTT), glutaraldehyde; enzymatic crosslinking, such as transglutaminase, and a combination of horseradish peroxidase (HRP) and hydrogen peroxide, or a residue thereof.

The hydrophilic agent, superhydrophilic agent, or precursors thereof, and/or film former when present, may comprise a functional group that is operable to be crosslinked, or residue thereof. For example, the hydrophilic agent, superhydrophilic agent, or precursors thereof, and/or film former when present, may comprise acid functionality, such as carboxylic acid functionality, or residues thereof. In the coating layer, the crosslinking density may be at least 2 molar % of the crosslinkable functional groups, such as at least 5 molar % or at least 10 molar %.

The crosslinking density may be at least 2 molar % of the crosslinkable functional groups.

As used herein, the crosslinking density was measured by the following method. The polymer was swelled in a solvent until equilibrium. The swollen gel was then isolated and weighed. The weights of swelling solvent and polymer were determined after removing the solvent by vacuum-drying. The following equation was then applied:

Crosslink density, network chain per gram=[In(1−Vp)+(Vp)+X(Vp)\hat{ }2]/{Dp(Vo)[(Vr)\hat{ }(⅓)−(Vp)/2]}
where
Vp=Volume fraction of polymer in the swollen polymer
X=Huggins polymer-solvent interaction constant
Dp=Density of polymer (g/cm\hat{ }3)
Vo=Molar volume of solvent (cm\hat{ }3/mol)
Do=Density of solvent (g/cm\hat{ }3)
Here,
Vp=1/(1+Q),
Where Q is the ratio of the weight of solvent in swollen polymer (XDp) and the weight of polymer (XDo).

The superhydrophilic agent may be a polyelectrolyte (co)polymer selected from a (meth)acrylic acid (co)polymer; and/or a styrene sulfonate acid (co)polymer, wherein at least part of the acid is in the form of a suitable salt.

The superhydrophilic agent may be a polyelectrolyte copolymer selected from poly(styrene-alt-maleic acid) sodium, chitosan-g-poly(acrylic acid) copolymer sodium; 2-propenoic acid, 2-methyl, polymer with sodium; and/or 2-methyl-2((1-oxo-2-propen-1-yl)amino)-1-propanesulfonate.

The superhydrophilic agent may comprise a (co)polymer hydrogel selected from: carboxymethyl cellulose (CMC), and/or polyvinylpyrrolidone (PVP) hydrogel, crosslinked for example by tetra(ethylene glycol) dimethacrylate, such as via free radical polymerisation, suitably wherein at least part of the acid is in the form of a suitable salt, such as a carboxymethyl cellulose (CMC) sodium; N-isopropylacrylamide (NIPAAm) with poly(ethylene glycol)-co-poly(ε-caprolactone) (PEG-co-PCL), crosslinked for example by N,N′-methylene bisacrylamide and/or sodium alginate, for example by using template copolymerisation, or UV light or crosslinked by N,N,N′,N′-tetramethylethylenediamine (TEMED) and/or ammonium persulphate (APS) with UV light, such as alginate and alginate derivatives; 3-(methacryloyloxy)propyltris(trimethylsiloxy)silane, N,N-dimethylacrylamide, 3-(methacryloyloxy)propyltris(trimethylsiloxy)silane 1-vinyl-2-pyrrolidinone, and/or 2-hydroxyethylmethacrylate (TRIS-DMA-NVP-HEMA copolymer hydrogel).

Hydrogel when used herein in relation to the hydrophilic agent and the superhydrophilic agent may mean an insoluble polymeric network characterized by the presence of physical and/or chemical crosslinking among the polymer chains and the presence of water, suitably in a non-insignificant amount, such as in an amount of at least 10% of the total weight of the polymer composition. The hydrophilic agent and/or the superhydrophilic agent may be in the form of a dehydrated hydrogel that is operable to form a hydrated hydrogel upon contact with water.

The superhydrophilic agent may comprise a poly(styrene sulphonate salt) and/or a polyacrylic acid salt.

The “term” precursor when used herein in relation to the hydrophilic and superhydrophilic agents refers to a compound that is operable to form the hydrophilic or superhydrophilic agent using methods known to the skilled person. For example, the precursor may be an oligomer, or pre-crosslinked polymer which form the hydrophilic or superhydrophilic agent after chemical or physical crosslinking, such as with UV-light with photo-initialiser, heat treatment, etc. For example, a precursor may comprise a mixture of acrylamide and acrylic acid monomers with poly(allylamonium chloride), and with 2,2′-Azobis(2-methylpropionamidine) dihydrochloride (AIBA) as initiator, and N,N′-methylene bisacrylamide (MBAM) as crosslinker. This mixture may be considered to be a hydrophilic agent precursor as it is operable to form a hydrophilic agent in the coating layer via template polymerisation. Another example of a suitable precursor includes polyethylene glycol (PEG) mixed with triethylene glycol dimethacrylate (TEGDMA), which is operable to form the hydrophilic agent in the coating layer via UV light with a photo-initiator.

The coating composition may comprise a buffer agent, operable to maintain the composition at suitable pH range, such as tris(hydroxymethyl)aminomethane (Tris). The pH of the coating composition may be from 8 to 9, such as from 8 to 8.5.

The thickness of the coating, suitably of the first coating layer, may be from 1 nm to 2000 nm

The thickness of the coating layer comprising the superhydrophilic agent may be up to 100 um.

The coating may comprise an intermediate layer between the membrane and a first coating layer, and/or between a first coating layer and a second coating layer.

The intermediate layer may comprise an adhesion promoter selected from silane or a derivative thereof, tannic acid, dopamine or a derivative thereof, and/or dopamine peptide; amine; diamine; methacrylate; epoxy; methyl, isobutyl, phenyl, octyl, or vinyl, chloroalkyl; vinylbenzylamino based adhesion promoter; organometallic such as organotitanate, organozirconate, organoaluminate; chlorinated or chlorine-free polyolefin; polyol based adhesion promoter; and/or polyester based adhesion promoter.

The adhesion promoter may comprise a silane based adhesion promoter such as an acrylate and/or methacrylate functional silane, aldehyde functional silane, amino functional silane; such as amino alkoxysilane, anhydride functional silane, azide functional silane, carboxylate phosphonate and/or sulfonate functional silane, epoxy functional silane, ester functional silane, halogen functional silane, hydroxyl functional silane, isocyanate and/or masked isocyanate functional silane, phosphine and/or phosphate functional silane, sulfur functional silane, vinyl and/or olefin functional silane, multi-functional and/or polymeric silane, UV active and/or fluorescent silane, and/or chiral silane, trihydrosilane.

The adhesion promoter may comprise 3-aminopropyl trimethoxy silane

The coated membrane may be formed by:
a. optionally, preparing a substrate by treating the membrane as described herein with physical rinsing, chemical treatment, radiation treatment, plasma treatment, and/or thermal treatment;
b. optionally, contacting the substrate with an intermediate layer coating composition to form an intermediate layer;
c. contacting the substrate/membrane with a coating composition comprising a hydrophilic agent or precursor thereof, and optionally further comprising a superhydrophilic agent or precursor thereof, to form a coating layer;
d. optionally, contacting the coating layer with an intermediate layer coating composition to form an intermediate layer;
e. if a superhydrophilic agent was not contacted with the substrate in step (c), contacting the coated substrate with a coating composition comprising a superhydrophilic agent or precursor thereof to form a further coating layer.

The coated membrane may be formed by:
a. optionally, preparing a substrate by treating the membrane with physical rinsing, chemical treatment, radiation treatment, plasma treatment, and/or thermal treatment;
b. optionally, contacting the substrate with an intermediate layer coating composition to form an intermediate layer;
c. optionally, contacting the substrate with a coating composition comprising a hydrophilic agent or precursor thereof to form a coating layer;
d. optionally, contacting the coating layer with an intermediate layer coating composition to form an intermediate layer;
e. contacting the optionally coated membrane with a coating composition comprising a superhydrophilic agent or precursor thereof to form coating layer;
wherein the coating layer comprising the superhydrophilic agent is at least partially crosslinked.

The coating may comprise a lamellar structure comprising at least two layers of two-dimensional material, and wherein the two-dimensional material comprises graphene or a derivative thereof. The coating may be formed from a coating composition comprising graphene or a derivative thereof.

The graphene or derivative thereof may be selected from one or more of graphene oxide, reduced graphene oxide, hydrated graphene and amino-based graphene, alkylamine functionalised graphene oxide, ammonia functionalised graphene oxide, amine functionalised reduced graphene oxide, octadecylamine functionalised reduced graphene oxide, and/or polymer graphene aerogel. Preferably, the graphene or derivative thereof is graphene oxide. Graphene and its derivatives may be obtained commercially from Sigma-Aldrich.

Suitably, the graphene or derivative thereof, preferably graphene oxide, comprises hydroxyl, carboxylic and/or epoxide groups. The oxygen content of the graphene or derivative thereof, preferably graphene oxide, may be 0% to 60% oxygen atomic percentage, such as 0% to 50% or 0% to 45% oxygen atomic percentage. Suitably, the oxygen content is from 20% to 25% or from 25% to 45%. Advantageously, when the water content is between 25% to 45% a surfactant may not be present in the composition. Preferably, the oxygen content is from 30% to 40% oxygen atomic percentage. Such a range can provide improved stability despite the absence of other stabilising components. Suitably, when the graphene or derivative is reduced graphene oxide, the oxygen content is from 5% to 20% oxygen atomic percentage. Oxygen content can be characterised by X-ray photoelectron spectroscopy (XPS).

The graphene or derivative thereof, suitably graphene oxide, may be optionally substituted with further functional groups. The optional functional groups may be grafted functional groups, and preferably grafted via reaction with the existing hydroxyl, carboxylic and epoxide groups of the graphene or derivative thereof. Functionalisation includes covalent modification and non-covalent modification. Covalent modification method can be subcategorized to nucleophilic substitution reaction, electrophilic substitution reaction, condensation reaction, and addition reaction. Examples of optional functional groups are amine groups; aliphatic amine groups, such as long-chain (e.g. C₁₈ to C₅₀) aliphatic amine groups; porphyrin-functionalised secondary amine groups, and/or 3-amino-propyltriethoxysilane groups. The graphene or derivative thereof may comprise amino groups, suitably grafted amino groups, and preferably to graphene oxide. Such functionalisation can provide for the improved selective sieving of ferric acid.

The graphene or derivative thereof according to any aspect of the present invention may be in the form of flakes having a size of from 1 nm to 5000 nm, such as between 50 nm to 750 nm, 100 nm to 50 nm, 100 nm to 400 nm. The graphene or derivative thereof according to any aspect of the present invention may be in the form of flakes having a size of from 100 nm to 3500 nm, such as from 200 nm to 3000 nm, 300 nm to 2500 nm or 400 nm to 2000 nm, preferably from 500 nm to 1500 nm. The graphene or derivative thereof according to any aspect of the present invention may be in the form of flakes having a size of from 500 nm to 4000 nm, 500 nm to 3500 nm, 500 nm to 3000 nm, 750 nm to 3000 nm, 1000 nm to 3000 nm, such as 1250 nm to 2750 nm or preferably 1500 nm to 2500 nm. Suitably, the size distribution of the graphene flakes or derivative thereof is such that at least 30 wt % of the graphene flakes or derivative thereof have a diameter of between 1 nm to 5000 nm, such as between 1 nm to 750 nm, 100 nm to 500 nm, 100 nm to 400 nm; or between 100 nm to 3500 nm, such as from 200 nm to 3000 nm, 300 nm to 2500 nm or 400 nm to 2000 nm, preferably from 500 nm to 1500 nm; or between 500 nm to 4000 nm, 500 nm to 3500 nm, 500 nm to 3000 nm, 750 nm to 3000 nm, 1000 nm to 3000 nm, such as 1250 nm to 2750 nm or preferably 1500 nm to 2500 nm, more preferably at least 40 wt %, 50 wt %, 60 wt %, 70 wt % and most preferably at least 80 wt % or at least 90 wt % or 95 wt % or 98 wt % or 99 wt %. The size of the graphene flakes or derivative thereof and size distribution may be measured using transmission electron microscopy (TEM, JEM-2100F, JEOL Ltd. Japan).

The graphene or derivative thereof may be in the form of a monolayer or multi-layered particle, preferably a monolayer. The graphene flakes or derivative thereof may be formed of single, two or few layers of graphene or derivative thereof, wherein few may be defined as between 3 and 20 layers. Suitably, the graphene flakes or derivative thereof comprise between 1 to 15 layers, such as between 2 to 10 layers or 5 to 15 layers. Suitably, at least 30 wt % of the graphene flakes or derivative thereof comprise between 1 to 15 layers, such as between 1 to 10 layers or 5 to 15 layers, more preferably at least 40 wt %, 50 wt %, 60 wt %, 70 wt % and most preferably at least 80 wt % or at least 90 wt % or 95 wt % or 98 wt % or 99 wt %. The number of layers in the graphene flakes or derivative thereof may be measured using atomic force microscopy (AFM or transmission electron microscopy (TEM)) (TT-AFM, AFM workshop Co., CA, USA).

Suitably, the d-spacing between adjacent lattice planes in the graphene or derivative thereof is from 0.34 nm to 1000 nm, such as from 0.34 nm to 500 nm, or from 0.4 nm to 500 nm, or from 0.4 nm to 250 nm, such as from 0.4 nm to 200 nm, or from 0.4 nm to 150 nm, or from 0.4 nm to 100 nm, or from 0.4 nm to 50 nm, or from 0.4 nm to 25 nm, or from 0.4 nm to 10 nm, or from 0.4 nm to 5 nm, such as from 0.45 nm to 4 nm, from 0.5 nm to 3 nm, 0.55 nm to 2 nm, or 0.55 nm to 1.5 nm, or 0.6 nm to 1.2 nm, for example 0.6 nm to 1.1 nm, 0.6 nm to 1 nm, 0.6 nm to 0.9 nm, or 0.6 nm to 0.8 nm.

The coating may comprise materials, suitably two-dimensional materials, other than graphene or derivatives thereof. For example, other materials of the coating may be selected from one or more of silicene, germanene, stanene, boron-nitride, suitably h-boron nitride, carbon nitride, metal-organic nanosheets, molybdenum disulfide, and tungsten disulfide, polymer/graphene aerogel.

The materials of the coating may be produced using any of the suitable methods known to the skilled person. Two-dimensional silicene, germanene and stanene may be produced by surface assisted epitaxial growth under ultrahigh vacuum. Hexagonal two-dimensional h-boron nitride may be produced by several methods, such as mechanical cleavage, unzipping of boron nitride nanotubes, chemical functionalisation and sonication, solid-state reaction and solvent exfoliation and sonication. Among these methods, chemical method has been found to provide the highest yield. For example, h-boron nitride may be synthesised on single-crystal transition metal substrates using borazine as boron and nitride sources. Two-dimensional carbon nitride can be prepared via direct microwave heating of melamine and carbon fibre. Metal-organic frameworks (MOFs) can be produced by in-situ solvothermal synthesis method by mixing ingredients at high temperatures such as 100-140° C., followed by filtration. Two-dimensional molybdenum disulfide can be obtained by a few methods, such as mechanical exfoliation, liquid exfoliation and chemical exfoliation. Among these methods, chemical exfoliation has been found to provide high yield. One example is chemical exfoliation using lithium to chemically exfoliate molybdenum disulfide using centrifuge and filtration. Two-dimensional tungsten disulfide can be prepared by a deposition-thermal annealing method: vacuum deposition of tungsten and followed by thermal annealing by addition of sulphur. Polymer/graphene aerogel can be produced via coupling and subsequent freeze-drying using polyethylene glycol grafted graphene oxide.

The method of applying the coating composition to the membrane may comprise applying a coating composition comprising the graphene or derivative thereof onto the membrane. The method may comprise contacting the coating composition onto the membrane using gravity deposition, vacuum deposition, pressure deposition; printing such as inkjet printing, aerosol printing, 3D printing, offset lithography printing, gravure printing, flexographic printing techniques, pad printing; curtain coating, dip coating, spin coating, and other printing or coating techniques known to those skilled in the art.

Further details of the application methods are disclosed in published PCT patent application WO2019106344, specifically, paragraphs [47] to [49] and [61] to [69] inclusive. The entire contents paragraphs [47] to [49] and [61] to [69] inclusive thereof are fully incorporated herein by reference.

The coating composition may be a liquid composition comprising a liquid medium and the graphene or derivative thereof. The coating compositions of the present invention may comprise solvent, non-solvent or solvent-less, and may be UV curable compositions, e-beam curable compositions etc. When formulated as a liquid composition for use in the invention, e.g. as a solution, dispersion or suspension, a suitable carrier liquid or solvent may be aqueous or organic, and other components will be chosen accordingly. For example, the liquid carrier may comprise water or an organic solvent such as ethanol, terpineol, dimethylformamide N-Methyl-2-pyrrolidone, isopropyl alcohol, mineral oil, ethylene glycol, or their mixtures, optionally with other materials to enhance performance and/or rheology of the composition including any one or more of binders, drying additives, antioxidants, reducing agents, lubricating agents, plasticisers, waxes, chelating agents, surfactants, pigments, defoamers and sensitizers.

Further details of the coating composition are disclosed in published PCT patent application WO2019106344, specifically, paragraphs [51] to [60] inclusive. The entire contents paragraphs [0051] to [0060] inclusive thereof are fully incorporated herein by reference.

The coating may comprise a lamellar structure comprising at least two layers of two-dimensional material, and wherein the two-dimensional material comprises a transition metal dichalcogenide. The coating may be formed from a coating composition comprising a transition metal dichalcogenide.

The transition metal dichalcogenide may be according to formula (I)

MₐX_{b}, (I)
wherein with M is a transition metal atom, such as Mo, W, Nb and Ni;
X is a chalcogen atom, preferably S, Se, or Te;
wherein 0≤a≤1 and 0≤b≤2.

The transition metal dichalcogenide may be selected from one or more of MoS₂, MoSe₂, WS₂, WSe₂, MoₐW₁₋ₐS₂, MoₐW₁₋ₐSe₂, MoS_{b}Se_{2-b}, WS_{b}Se_{2-b}, or MoₐW₁₋ₐS_{b}Se_{2-b}, where 0≤a≤1 and 0≤b≤2, or combination thereof. Preferably, the transition metal dichalcogenide is selected from MoS₂, WS₂, MoSe₂, WSe₂. Most preferably from MoS₂ and WS₂. Such transition metal dichalcogenide is available commercially from ACS Material.

The transition metal dichalcogenide may be in the form of flakes having an average size of from 1 nm to 5000 nm, such as between 50 to 750 nm, 75 nm to 500 nm, 100 nm to 400 nm, for example 130 nm to 300 nm, 150 nm to 290 nm, or 160 nm to 280 nm, suitably 170 nm to 270 nm, 180 nm to 260 nm or preferably 190 nm to 250 nm. Suitably, the size distribution of the transition metal dichalcogenide flakes is such that at least 30 wt % of the transition metal dichalcogenide flakes have a diameter of between 1 nm to 5000 nm, such as between 50 to 750 nm, 75 nm to 500 nm, 100 nm to 400 nm, for example 130 nm to 300 nm, 150 nm to 290 nm, or 160 nm to 280 nm, suitably 170 nm to 270 nm, 180 nm to 260 nm or preferably 190 nm to 250 nm more preferably at least 40 wt %, 50 wt %, 60 wt %, 70 wt % and most preferably at least 80 wt % or at least 90 wt % or 95 wt % or 98 wt % or 99 wt %. The size of the transition metal dichalcogenide thereof and size distribution may be measured using transmission electron microscopy (TEM, JEM-2100F, JEOL Ltd. Japan).

For example, lateral sizes of the two-dimensional layers across a sample may be measured using transmission electron microscopy (TEM, JEM-2100F, JEOL Ltd. Japan), and the number (Nᵢ) of the same sized nanosheets (Mᵢ) measured. The average size may then be calculated by Equation 1:

Average size=Σᵢ₌₁^{∞}NᵢMᵢ/Σᵢ₌₁^{∞}Nᵢ

where Mᵢ is diameter of the nanosheets, and Ni is the number of the size with diameter Mᵢ.

The transition metal dichalcogenide may be in the form of a monolayer or multi-layered particle or flake, preferably a monolayer. The transition metal dichalcogenide flakes may be formed of single, two or few layers of transition metal dichalcogenide, wherein few may be defined as between 3 and 100 layers. Suitably, the transition metal dichalcogenide flakes comprise between 1 to 100 layers, such as between 2 to 75 layers or 5 to 50 layers or 10 to 25 layers. Suitably, at least 30 wt % of the transition metal dichalcogenide comprise between 1 to 30 layers, such as between 5 to 30 layers or 5 to 10 layers, more preferably at least 40 wt %, 50 wt %, 60 wt %, 70 wt % and most preferably at least 80 wt % or at least 90 wt % or 95 wt % or 98 wt % or 99 wt %. The number of layers in the transition metal dichalcogenide flakes thereof may be measured using atomic force microscopy (AFM or transmission electron microscopy (TEM)) (TT-AFM, AFM workshop Co., CA, USA).

Suitably, the d-spacing between adjacent lattice planes in the transition metal dichalcogenide or mixture thereof is from 0.34 nm to 5000 nm, such as from 0.34 nm to 1000 nm, or from 0.4 to 500 nm, or from 0.4 to 250 nm, such as from 0.4 to 200 nm, or from 0.4 to 150 nm, or from 0.4 to 100 nm, or from 0.4 to 50 nm, or from 0.4 to 25 nm, or from 0.4 to 10 nm, or from 0.4 to 8 nm, such as from 0.4 to 7 nm, from 0.45 to 6 nm, 0.50 to 5 nm, or 0.55 to 4 nm, or 0.6 to 3 nm, for example 0.6 to 2.5 nm, 0.6 to 1 nm, 0.6 to 2 nm, or 0.6 to 1.5 nm.

The coating may comprise materials, suitably two-dimensional materials, other than the transition metal dichalcogenide thereof. For example, other materials of the coating may be selected from one or more of silicene, germanene, stanene, boron-nitride, suitably h-boron nitride, carbon nitride, metal-organic nanosheets, graphene, graphene oxide, reduced graphene oxide functionalised graphene oxide and polymer/graphene aerogel.

Further details of the application methods are disclosed in published PCT patent application WO2019/122828, specifically, paragraphs [73] to [77] inclusive. The entire contents paragraphs [73] to [77] inclusive thereof are fully incorporated herein by reference.

Further details of the coating composition are disclosed in published PCT patent application WO2019/122828, specifically, paragraphs [46] to [61] inclusive. The entire contents paragraphs [0046] to [0061] inclusive thereof are fully incorporated herein by reference.

The coating may comprise a metal-organic framework (MOF). The coating may be formed from a coating composition comprising a MOF.

The metal-organic framework materials of any aspect of the present invention may be one-dimensional, two-dimensional or three-dimensional. Preferably, the MOF is porous. The MOF may comprise a network of secondary building units (SBUs), or metal ion core/metal subunit cluster core nodes, and organic linkers (or ligands) connecting the SBUS or nodes.

The MOF may be in continuous phase in the coating or may be in the form of flakes and/or particles. A MOF synthesised in the presence of first support portion may be in the form of continuous phase. A MOF formed prior to contact with the first support portion may be in the form of flakes and/or particles.

The SBUs or nodes, being sub units of the MOF, may comprise metal selected from one or more transition metal cations, such as one or more of Cr(III), Fe(II), Fe(III), Al(III), Co(II), Ru(III), Os(III), Hf(IV), Ni, Mn, V, Sc, Y(III), Cu(II), Cu(I), Zn(II), Zr(IV), Cd, Pb, Ba, Ag (I), Au, AuPd, Ni/Co, lanthanides, actinides, such as Lu, Tb(III), Dy(III), Ho(III), Er(III), Yb(III). Preferably Cr(III), Fe(II), Fe(III), Al(III), Co(II), Ru(III), Os(III), Hf(IV), Ni, Mn, V, Sc, Y(III), Cu(II), Cu(I), Zn(II), Zr(IV), Cd, Pb, Ba, Ag (I), Ni/Co, lanthanides, actinides, such as Lu, Tb(III), Dy(III), Ho(III), Er(III), Yb(III). More preferably Cr(III), Fe(II), Fe(III), Al(III), Co(II), Hf(IV), Ni, Mn, V, Sc, Y(III), Cu(II), Cu(I), Zn(II), Zr(IV), Cd, Pb, Ag (I), Ni/Co, lanthanides, actinides, such as Lu, Tb(III), Dy(III), Ho(III), Er(III), Yb(III), more preferably Cr(III), Fe(II), Fe(III), Al(III), Co(II), Hf(IV), Ni, Mn, V, Y(III), Cu(II), Cu(I), Zn(II), Zr(IV), Cd, Ag (I), Ni/Co, lanthanides, actinides, such as Lu, Tb(III), Dy(III), Ho(III), Er(III), Yb(III). The secondary building unit (SBU) may comprise: three, four, five, six, eight, nine, ten, eleven, twelve, fifteen or sixteen points of extension.

The SBU or node may be a transition-metal carboxylate cluster. The SBUs or nodes may be one or more selected from the group consisting of Zn4O(COO)6, Cu2(COO)4, Cr3O(H2O)3(COO)6, and Zr6O4(OH)10(H2O)6(COO)6), Mg2(OH2)2(COO), RE4(ρ3-O)2(COO)8, RE4(ρ3-0)2, wherein RE is Y(III), Tb(III), Dy(III), Ho(III), Er(III), and/or Yb(III)). The structures of SBUs can be identified by X-Ray diffraction using methods well known to the skilled person.

Organic linkers suitable for use in the present invention include those operable to be used to form MOFs for water treatment, molecule separation, and biofiltration related applications. Such linkers may form strong bonds to metal cores, provide large pore sizes, provide high porosity, provide selective absorption and/or capacity.

The organic linkers of the MOF may be formed from a wide range of organic molecules, such as one or more carboxylate linkers; N-heterocyclic linkers; phosphonate linkers; sulphonate linkers, metallo linkers, such a carboxylate-metallo linkers; and mixtures and derivatives thereof.

The organic linkers may comprise one or more of ditopic, tritopic, tetratopic, hexatopic, octatopic linkers. The organic linkers may comprise desymmetrised linkers.

MOFs suitable for use in the present invention include those operable to be used water treatment, molecule separation, biofiltration and related applications. Suitable MOFs preferably have water and chemical stability. The MOFs may have water insoluble linkers, and/or solvent-stable linkers, and/or strong covalent bonds between SBU and linkers, and/or multi-covalent bonds between SBU and linkers. Water and chemical stability may mean that the MOFs do not fully disassemble to linkers and SBUs in the presence of water and/or chemicals. Suitable MOFs may have covalent bond links between the linkers and the SBUs or nodes, and/or coordinate bonding between the linkers and the SBUs or nodes.

Suitable MOFs may have high surface area and/or large pore sizes. The MOF may have surface area of at least 10 m²/g, such as 100 to 9,000 m²/g, preferably 100 to 8,000 m²/g or 500 to 8,000 m²/g. The surface area can be measured using the known Brunauer, Emmett and Teller (BET) technique. The MOFs according to any aspect of the present invention, suitably in the form of porous flakes or particles, may have an average pore size of from 0.1 nm to 1000 nm, 0.1 to 950 nm, 0.2 to 900 nm, 0.2 to 850 nm, preferably 0.2 to 800 nm, 0.3 to 700 nm, preferably 0.4 to 650, 0.4 to 550 nm, 0.5 to 500 nm, 0.5 to 450 nm, 0.2 nm to 100 nm, such as between 0.2 nm to 90 nm, 0.3 nm to 75 nm, 0.4 nm to 50 nm, for example 0.4 nm to 40 nm, 0.4 nm to 30 nm, or 0.4 nm to 20 nm, suitably 0.4 nm to 15 nm, 0.4 nm to 10 nm.

The MOF may comprise a pillared-layer MOF. Suitably, in a pillared-layer MOF 2D sheets function as scaffolds for organic linkers, such as dipyridyl linkers. Advantageously, this can allow for diverse functionalities to be incorporated into the MOF, such as —SO₃²⁻_groups. The use of —SO₃²⁻_groups can induce a polarized environment and strong acid-base interaction with acidic guests like CO2. Furthermore, different pillar linker groups, such as —N═N— compared to —CH═CH—, provide different selectivity to H₂O and methanol.

The MOF may comprise a functional group. The MOF may in particular be adapted for water treatment, molecule separation, and biofiltration related applications by the MOF comprising a functional group, suitably on one or more of the organic linkers. Said functional groups may provide selectivity and/or increase pore sizes for high adsorption capacity or high flux rate. The functional group may be selected from one or more of the group consisting of —NH₂, —Br, —Cl, —I, —(CH₂)ₙ—CH₃ wherein n is 1 to 10, such as CH₃CH₂CH₂O—, CH₃CH₂CH₂CH₂O—, ben-C₄H₄, methyl, —COOH, —OH. For example, the MOF may be an IRMOF, such as IRMOF-1, IRMOF-2, IRMOF-3, IRMOF-4, IRMOF-5, IRMOF-6, IRMOF-7, IRMOF-8, IRMOF-9, IRMOF-10, IRMOF-16, IRMOF-11, IRMOF-12, IRMOF-13, IRMOF-14, IRMOF-15; and/or a CAU, such as CAU-10-OH, CAU-10-NH₂, CAU-10-H, CAU-10-CH₃; and/or MIL-125-NH2; and/or UiO-66(Zr)—(CH3)2.

The coating may be operable to provide size exclusion filtration, fouling resistance, and/or adsorption, such as size exclusion and fouling resistance.

The pore size of the MOF may be tailored by using different species of MOFs or different organic linkers with different lengths. For example, the pore size of the MOF may be at least 0.6 nm (e.g. ZIF-78), such as at least 0.8 nm (e.g. ZIF-81), or at least 0.9 nm (e.g. ZIF-79) or at least 1.2 nm (e.g. ZIF-69), or at least 1.3 nm (e.g. ZIF-68) or at least 1.6 nm (e.g. ZIF-82), such as at least 1.8 nm (e.g. ZIF-70), or at least 1.8 nm (e.g. IRMOF-10), or at least 2.8 nm (e.g. MOF-177).

The MOF may comprise MOF-74 adapted by replacing one or more of the original linkers containing one phenyl ring with a linker containing two, three, four, five, six, seven, nine, ten or eleven phenyl rings. Such an adaption can alter the pore size from ˜1.4 nm to ˜2.0 nm, to ˜2.6 nm, to ˜3.3 nm, to ˜4.2 nm, to ˜4.8 nm, to ˜5.7 nm, to ˜7.2 nm, to ˜9.5 nm, respectively.

The MOF may be hydrophobic. The hydrophobic MOF may be selected from one or more of MIL-101(Cr), NiDOBDC, HKUST-1, AI(OH)(2,6-ndc) (ndc is naphthalendicarboxylate), MIL-100-Fe, UiO-66, ZIF family, such as ZIF 71, ZIF 74, ZIF-1, ZIF-4, ZIF-6, ZIF-11, ZIF-9, and ZIF 8. Advantageously, the use of such MOFs can improve the fouling resistance of the membrane.

The MOF may comprise an adsorption promoting MOF, for example UiO-66 or UiO-66-NH2, preferably UiO-66-NH2, which has been found to adsorb cationic dyes from aqueous solution more effectively than anionic dyes due to favourable electrostatic interactions between the adsorbents and cationic dyes. In particular, UiO-66-NH2 has been found to provide much higher adsorption capacity for cationic dyes and lower adsorption capacity for anionic dyes than UiO-66.

The MOFs may comprise nanochannels, suitably the MOFs are in the form of flakes or particles comprising nanochannels. The average nanochannel diameter may be from 0.2 nm to 100 nm, such as between 0.2 to 90 nm, 0.3 nm to 75 nm, 0.4 nm to 50 nm, for example 0.5 nm to 40 nm, 0.5 nm to 30 nm, or 0.5 nm to 20 nm, suitably 0.5 nm to 15 nm, 0.5 nm to 10 nm or preferably 0.5 nm to 8 nm.

The MOF may comprise functional groups selected from one or more of amine, aldehyde, alkynes, and/or azide. MOFs pores may be modified for selective sieving and to provide higher efficiency by modification methods, suitably post-synthetic, on the linkers and/or the secondary building units/nodes, such as covalent post-synthetic modification method of amine, or aldehyde, or alkynes, or azides functional groups. Specific functional groups may be induced to MOF(s) for specific application. For example, adding —NH2 to UiO-66 to make UiO-66-NH2 has been found to improve ferric acid adsorption, and adding sulfone bearing groups to iso IRMOF-16 by, for example, oxidation using dimethyldioxirane, in order to create compatible interaction between the coating and first support portion.

The MOFs of the present invention may be synthesised according to the required property or purchased from commercial supplier. Suitable commercially available metal-organic framework materials can be purchased from BASF, Sigma-Aldrich, or Strem Chemicals.

The methods used to synthesise MOFs for the current invention are those conventional in the art and may be solvothermal synthesis, microwave-assisted synthesis, electrochemical synthesis etc.

A modulator may be used during synthesis of the MOF to control the MOF particle size, the modulator may be benzoic acid.

The MOF may be in the form of a crystallised continuous phase or particles or flakes compacted and interacting or fused to each other forming the coating. Preferably the MOF is in the form of particles or flakes.

The size distribution of the MOF flakes or particles may be such that at least 30 wt % of the MOF flakes or particles have a size of between 1 nm to 10000 nm, such as between 2 to 7500 nm, 5 nm to 5000 nm, 10 nm to 4000 nm, for example 15 nm to 3500 nm, 20 nm to 3000 nm, or 25 nm to 3000 nm, suitably 30 nm to 2500 nm, 40 nm to 2500 nm or preferably 50 nm to 2500 nm more preferably at least 40 wt %, 50 wt %, 60 wt %, 70 wt % and most preferably at least 80 wt % or at least 90 wt % or 95 wt % or 98 wt % or 99 wt %. The size of the MOF and size distribution may be measured using transmission electron microscopy (TEM, JEM-2100F, JEOL Ltd. Japan).

For example, lateral sizes of two-dimensional layers across a sample of a MOF may be measured using transmission electron microscopy (TEM, JEM-2100F, JEOL Ltd. Japan), and the number (Ni) of the same sized nanosheets (Mᵢ) measured. The average size may then be calculated by Equation 1:

Average size=Σᵢ₌₁^{∞}NᵢMᵢ/Σᵢ₌₁^{∞}Nᵢ
where Mᵢ is diameter of the nanosheets, and Nᵢ is the number of the size with diameter Mᵢ.

The coating may comprise additives to tailor the properties of the coating, such as other metals; and/or fibres, such as metal oxide nanostrands; and/or dopants such as Au, Fe, Cu, Cu(OH)₂, Cd(OH)₂ and/or Zr(OH)₂. Such additives may be added to the membrane to control the pore sizes and channel architecture of MOF and/or create nanochannels for high water flux rate. Any type of suitable fibres, such as continuous or stapled fibres, having diameter of 0.1-1000 nm may be incorporated within the membrane. Such as 0.1 to 850 nm, 0.5 to 500 nm, or 0.5 to 100 nm, 0.75 to 75 nm, preferably, 0.75 to 50 nm. Suitably, the fibres are removed before use, such as by mechanical removal or by dissolution, etc.

Further details of the application methods are disclosed in published PCT patent application WO2019/186134, specifically, paragraphs [117], [118] and [126] to [130] inclusive. The entire contents paragraphs [117], [118] and [126] to [130] inclusive thereof are fully incorporated herein by reference.

Further details of the coating composition are disclosed in published PCT patent application WO2019/186134, specifically, paragraphs [97] to [116] inclusive. The entire contents paragraphs [97] to [116] inclusive thereof are fully incorporated herein by reference.

The coating may further comprise nanochannels formed by the use of fibres in the production of the coating. Advantageously the presence of nanochannels within the coating have been found to significantly increase the water flux by incorporating continuous or chopped fibres having diameter of 0.5-1000 nm during the manufacture process followed by removal of the fibres.

The nanochannels in the coating may have a diameter of 1 to 750 nm, such as 1 to 500 nm, or 1 to 250 nm, for example 1 to 150 nm or 1 to 100 nm, for example 1 to 50 nm or 1 to 25 nm, such as 1 to 10 nm or preferably 1 to 5 nm.

The two-dimensional material of the coating may be treated two-dimensional material. The two-dimensional material may be treated after formation of the coating. The treatment may to cause a change to the functional groups of the two-dimensional material, such as by application of high energy radiation such as laser radiation, chemicals, heat, thermal heat and/or pressure to the two-dimensional material.

The two-dimensional material may be treated, suitably reduced, by exposing the two-dimensional material to radiation, such as laser radiation, microwave radiation, UV radiation, E-beam radiation, plasma treatment, electron radiation, soft X-ray radiation, gamma radiation, alpha radiation; chemical treatment, pressure treatment and/or thermal treatment, preferably, laser radiation and/or plasma treatment.

The coating may comprise multiple coating layers, wherein at least one of the layers was treated before deposition of a subsequent layer. Preferably, each layer was treated before deposition of the subsequent layer. The layers of coating layer comprising multiple coating layers may have been subjected to different treatments, in terms of the type of treatment and/or the extent of the treatment. As such, at least one of the layers may comprise two-dimensional material having different functionality to another layer. For example, the layers may comprise a gradient of decreasing reduction level in the two-dimensional material from the top of the coating layer towards the bottom of the coating layer adjacent to the membrane. The gradient may be created in the reverse direction.

The presence of the gradient may increase the adhesion between the coating and substrate, and may also increase the fouling resistance of the overall membrane.

Treatment of the two-dimensional material on the membrane may cause a change in the functional groups of the two-dimensional material, for example changed the number, species and/or distribution of the functional groups. For example, treatment may reduce the two-dimensional material and/or may functionalize the two-dimensional material by the adding functionality to the two-dimensional material.

Treatment of the two-dimensional material thereof to functionalize the two-dimensional material may add or change the functional groups of the two-dimensional material, for example by reaction with existing hydroxyl, carboxylic and/or epoxide groups of the two-dimensional material. Functionalisation includes covalent modification and non-covalent modification. Covalent modification method can be subcategorized to nucleophilic substitution reaction, electrophilic substitution reaction, condensation reaction, and addition reaction.

The two-dimensional material may be treated, suitably reduced, by exposing the two-dimensional material to radiation, such as laser radiation, microwave radiation, UV radiation, E-beam radiation, plasma treatment, electron radiation, soft X-ray radiation, gamma radiation, alpha radiation; chemical treatment and/or thermal treatment. Preferably, laser radiation and plasma treatment.

Chemical, thermal or radiation treatment of the two-dimensional material on the membrane can be used to form chemically reduced GO (CRGO), thermally reduced graphene oxide (TRGO) or radiation reduced graphene oxide (RRGO).

The hydrophilicity of treated membrane may be controlled by the functional groups or polar atom percentage, such as oxygen or nitrogen left at the surface after treatment.

The membrane may be used in the treatment and separation of water from contaminants.

The membrane may be used in chemical separation, protein separation, produced water treatment or industrial wastewater treatment that requires high temperature operation and/or harsh pH environments.

The membrane according to the present invention may be operable for use in applications where suspended solid particulates are effectively required to be removed from the feed solution in an energy efficient method. Accordingly, the membrane may be operable for use in, but is not limited to, applications such as concentrating algae, concentrating and clarifying high solid contents juices, separating proteins from milk, clarifying produced/waste water, concentrating enzymes; sugar refining, such as separating calcium carbonate from sugar feed; critical metal extraction, such as lithium, tungsten, gold and/or silver.

The membrane according to the present invention may be operable for use in desalination; for separation of sodium, magnesium, molybdenum, and/or lithium.

In the membrane of the present invention, pressure may be used to push the water through the membrane portion where contaminates are separated out and left in the water feed and uncontaminated water passes through onto the permeate side, where it is pushed through the membrane towards the permeate flow outlet.

The membrane may be operable for use in applications where suspended solid particulates are effectively required to be removed from the feed solution in an energy efficient method. Accordingly, the membrane may be operable for use in, but is not limited to, applications such as concentrating algae, concentrating and clarifying high solid contents juices, separating proteins from milk, clarifying produced/waste water, concentrating enzymes; sugar refining, such as separating calcium carbonate from sugar feed; critical metal extraction, such as lithium, tungsten, gold and/or silver.

The membrane may be operable for use in applications where divalent and trivalent cations are effectively required to be removed from the feed solution in an energy efficient method. Accordingly, the membrane may be operable for use in, but is not limited to, applications such as water softening, critical metal extraction.

The membrane may be a microfiltration membrane (MF), which may be used in areas such as to remove bacteria, cysts, yeast cells, suspending particles, pigments, and asbestos.

The membrane may be an ultrafiltration membrane (UF), which may be used in areas such as to remove proteins, colloidal particles and viruses.

The membrane may be a nanofiltration membranes (NF), which may be used in areas such as to select multivalent ions, dissolved compounds, medium sized organic molecules, small proteins, small colloidal particles.

According to a further aspect of the present invention, there is provided a separation portion for use in an apparatus for reducing the ratio of divalent ions to a monovalent ion in an aqueous solution from a source aqueous solution that contains a higher ratio of divalent ions to the monovalent ion, the separation portion comprising a membrane according to any aspect of the present invention.

The apparatus for reducing the ratio of divalent ions to a monovalent ion in an aqueous solution from a source aqueous solution that contains a higher ratio of divalent ions to the monovalent ion may comprise;
optionally a prefiltration portion operable to receive the source aqueous solution and produce a prefiltered aqueous solution;
a first separation portion operable to receive the optionally prefiltered aqueous solution and form an intermediate aqueous solution having a lower ratio of divalent ions to the monovalent ion than the optionally prefiltered aqueous solution; and/or
a second separation portion operable to receive the intermediate aqueous solution and form a product aqueous solution having a lower ratio of the divalent ions to the monovalent ion than the intermediate solution.

The separation portion comprising a membrane according to any aspect of the present invention may be the prefiltration portion, first and/or second separation portion, such as the prefiltration and/or first separation portion.

According to a further aspect of the present invention, there is provided an apparatus for reducing the ratio of divalent ions to a monovalent ion in an aqueous solution from a source aqueous solution that contains a higher ratio of divalent ions to the monovalent ion, wherein the apparatus comprises;
optionally a prefiltration portion operable to receive the source aqueous solution and produce a prefiltered aqueous solution;
a first separation portion operable to receive the optionally prefiltered aqueous solution and form an intermediate aqueous solution having a lower ratio of divalent ions to the monovalent ion than the optionally prefiltered aqueous solution; and/or
a second separation portion operable to receive the intermediate aqueous solution and form a product aqueous solution having a lower ratio of the divalent ions to the monovalent ion than the intermediate solution,
wherein the prefiltration portion, the first and/or the second separation portion comprises a separation portion comprising a membrane according to any aspect of the present invention.

According to a further aspect of the present invention, there is provided a process for reducing the ratio of divalent ions to a monovalent ion in an aqueous solution, comprising:
a. optionally, contacting a source aqueous solution comprising the divalent ions and the monovalent ion with a prefiltration portion operable to produce a prefiltered aqueous solution;
b. contacting the optionally prefiltered aqueous solution with a first separation portion to form an intermediate aqueous solution having a lower ratio of the divalent ions to the monovalent ion than the optionally prefiltered aqueous solution;
c. contacting the intermediate solution with a second separation portion to form a product aqueous solution having a lower ratio of the divalent ions to the monovalent ion than in the intermediate solution,
wherein the prefiltration portion, the first and/or the second separation portion comprises a separation portion comprising a membrane according to any aspect of the present invention.

According to a further aspect of the present invention, there is provided a product aqueous solution obtained by the process for reducing the ratio of divalent ions to a monovalent ion in an aqueous solution of the present invention.

The separation portion, apparatus and/or process of the aspects of the present invention may be for use in critical metal extraction, such as for lithium, tungsten, tin, gold and/or silver extraction.

The separation portion, apparatus and/or process of the aspects of the present invention may be for use in lithium extraction, such as for direct lithium extraction (DLE). The aqueous solution obtainable by the apparatus and/or obtained by the process of the present invention may be operable to produce an aqueous solution comprising the monovalent ion, such as lithium, in an amount of ≥100 ppm substantially in the absence of divalent ions, and in a purity of ≥99.5% when dried. As used herein, “substantially in the absence of divalent ions” may mean that divalent ions are present in an amount of <10 ppm, such as <5 ppm or <1 ppm.

The first separation portion may comprise a nanofiltration membrane according to any aspect of the present invention.

The nanofiltration membrane may have a divalent ion rejection of ≥70%, such as ≥80% or ≥90%. The nanofiltration membrane may have a divalent ion rejection of ≤99%, such as ≤98% or ≤95%.

The nanofiltration membrane may have rejection rate for the monovalent ion of ≤50%, such as ≤40% or ≤30%.

The second separation portion may comprise an ion-exchange resin.

The ion-exchange resin of the second separation portion may comprise a microporous (gel-type) and/or macroporous (porous type) resin.

The ion-exchange resin of the second separation portion may comprise a macroporous (porous type) resin.

The ion-exchange resin of the second separation portion may be weakly acidic, such as by comprising carboxylic acid functionality.

The exchange resin of the second separation portion may comprise a chelating group, such as an iminodiacetic acid group, thiourea group, amino methyl phosphonic acid group, and/or Di-2-ethylhexylphosphat (D2EHPA) group, and/or a residue thereof. The exchange resin of the second separation portion may comprise a chelating iminodiacetic acid group or residue thereof.

The ion-exchange resin may comprise a polymer comprising a polystyrene and/or polyacrylic backbone, and/or comprising a sulfonic and/or carboxylic functional group. Some examples of commercially available resins include: Lanxess Lewatit TP 207, Lewatit TP 208, Amberlite IRC 748, Purolite S 930 (weakly acidic, macroporous cation exchange resin with chelating iminodiacetic acid groups); Lanxess Lewatit TP 214 (weakly acidic, macroporous cation exchange resin with chelating thiourea groups); Lanxess Lewatit TP 260 (weakly acidic, macroporous cation exchange resin with chelating amino methyl phosphonic acid groups); and/or Lanxess Lewatit VP OC 1026 (weakly acidic, macroporous cation exchange resin with chelating Di-2-ethylhexylphosphat (D2EHPA) groups).

The source aqueous solution may be obtained from a brine source or from hard rock that contains the monovalent ion. The source aqueous solution may be seawater brine, saline lake brine, shallow groundwater brine, geothermal brine, deep brine in sedimentary basin or industrial brine. The source aqueous solution may be a geothermal brine, such as a geothermal brine obtained from a deep or a shallow geothermal source. The source aqueous solution may be leachate produced after processing, for example roasting, a mineral rock source, such as Spodumene mineral.

The source aqueous solution may be an ocean seawater brine; a shallow brine beneath a dry lake, such as from Clayton Valley, Nevada, and/or Salar de Olaroz mine, Argentina; a geothermal brine, such as from Cornwall, United Kingdom and/or Salton Sea, California; and/or a deep brine, such as from Paradox Basin, Utah.

The source aqueous solution may be a deep or shallow geothermal brine, such as from Cornwall, United Kingdom and/or Salton Sea, California. The source aqueous solution may be a deep geothermal brine, such as from Cornwall, United Kingdom. A deep geothermal brine may be defined as brine extracted from a depth of >150 m. A shallow geothermal brine may be defined as brine extracted from a depth of ≤150 m.

The source solution may comprise divalent cations, and optionally trivalent cations, such as Ca, Mg, B, Ba, Fe, Mn, Zn, Mo, Sr, Zr, V, Cr, Te, Ti, Ga, Hg, Be, In, Ta, Ce, Hf, Sm, La, Nb, Th, Al, TI, As, Ni, Cu, Sc, Sn, Sb, Co, Pb, U, Cd, Y and/or Bi. Preferably, Ca, Mg and/or B.

The monovalent ion of the source solution may comprise a cation, such as Na, K, Li, Cs, Rb, W, Au and/or Ag. Preferably, the monovalent ion of the source solution comprises Li, W, Au, Ag, Na and/or K. More preferably, Li, W, Au and/or Ag. Most preferably, Li. The source solution may comprise anions, such as Cl, F, Br, SO₄, HCO₃, and/or CO₃. The source solution may preferably comprise Cl and/or SO₄.

The source aqueous solution may comprise total suspended solids in an amount of ≥1 ppm, such as ≥5 ppm or ≥50 ppm. The source aqueous solution may comprise total suspended solids in an amount of ≤2000 ppm, such as ≤1500 ppm or ≤1000 ppm, or ≤500 ppm. The source solution may comprise a ratio of divalent ions to the monovalent ion of ≤500:1, such as ≤250:1, or such as ≤150:1. The source solution may comprise divalent ions in an amount of ≤80,000 ppm, such as ≤50,000 ppm or ≤30,000 ppm. The source solution may comprise the monovalent ion in an amount of ≤3000 ppm, such as ≤2000 ppm or ≤1000 ppm. The source solution may comprise a ratio of divalent ions to the monovalent ion of ≥0.5:1, such as ≥5:1, such as ≥8:1, or such as ≥12:1. The source solution may comprise a ratio of divalent ions to the monovalent ion of ≤200:1, such as ≤100:1, or such as ≤50:1. The source solution may comprise divalent ions in an amount of ≥1,000 ppm, such as ≥2,000 ppm or ≥3,000 ppm. The source solution may comprise divalent ions in an amount of ≤10,000 ppm, such as 55,000 ppm or ≤4,000 ppm. The source solution may comprise the monovalent ion in an amount of ≥50 ppm, such as ≥150 ppm or ≥200 ppm. It will be appreciated that the aqueous solutions may comprise other monovalent ions in addition to the target monovalent ion. The source solution may comprise the monovalent ion in an amount of ≤2000 ppm, such as ≤1000 ppm or ≤500 ppm.

The prefiltered aqueous solution may comprise divalent cations, and optionally trivalent cations, such as Ca, Mg, B, Ba, Fe, Mn, Zn, Mo, Sr, Zr, V, Cr, Te, Ti, Ga, Hg, Be, In, Ta, Ce, Hf, Sm, La, Nb, Th, Al, TI, As, Ni, Cu, Sc, Sn, Sb, Co, Pb, U, Cd, Y, and/or Bi. Preferably, Ca, Mg and/or B. The monovalent ion of the source solution may comprise a cation, such as Na, K, Li, Cs, Rb, W, Au, and/or Ag. Preferably, the monovalent ion of the prefiltered solution comprise Li, W, Au, Ag, Na and/or K. More preferably, Li, W, Au and/or Ag. Most preferably, Li. The source solution may comprise anions, such as Cl, F, Br, SO₄, HCO₃, and/or CO₃. The source solution may preferably comprise Cl and/or SO₄.

The prefiltered aqueous solution may comprise a lower amount of total suspended solids, such as silica, bacteria, and/or oil/grease, than the source aqueous solution. The prefiltered aqueous solution may comprise total suspended solids in an amount of ≤100 ppm, such as ≤50 ppm or ≤10 ppm.

The prefiltered aqueous solution may comprise a ratio of divalent ions to the monovalent ion of ≤500:1, such as ≤250:1, or such as ≤150:1. The prefiltered aqueous solution may comprise divalent ions in an amount of ≤80,000 ppm, such as ≤50,000 ppm or ≤30,000 ppm.

The prefiltered aqueous solution may comprise the monovalent ion in an amount of ≤3000 ppm, such as ≤2000 ppm or ≤1000 ppm. The prefiltered aqueous solution may comprise substantially the same amounts of divalent and monovalent ions as the source aqueous solution.

The prefiltered solution may comprise a ratio of divalent ions to the monovalent ion of ≥0.5:1, such as ≥5:1, such as ≥8:1, or such as ≥12:1. The prefiltered solution may comprise a ratio of divalent ions to the monovalent ion of ≤200:1, such as ≤100:1, or such as ≤50:1. The prefiltered solution may comprise divalent ions in an amount of ≥1,000 ppm, such as ≥2,000 ppm or ≥3,000 ppm. The prefiltered solution may comprise divalent ions in an amount of ≤10,000 ppm, such as ≤5,000 ppm or ≤4,000 ppm. The prefiltered solution may comprise the monovalent ion in an amount of ≥50 ppm, such as ≥150 ppm or ≥200 ppm. It will be appreciated that the aqueous solutions may comprise other monovalent ions in addition to the target monovalent ion. The prefiltered solution may comprise the monovalent ion in an amount of ≤2000 ppm, such as ≤1000 ppm or ≤500 ppm.

The intermediate solution may comprise divalent cations, and optionally trivalent cations, such as Ca, Mg, B, Ba, Fe, Mn, Zn, Mo, Sr, Zr, V, Cr, Te, Ti, Ga, Hg, Be, In, Ta, Ce, Hf, Sm, La, Nb, Th, Al, TI, As, Ni, Cu, Sc, Sn, Sb, Co, Pb, U, Cd, Y, and/or Bi. Preferably, Ca, Mg and/or B.

The monovalent ion of the intermediate source solution may comprise a cation, such as Na, K, Li, Cs, Rb, W, Au, and/or Ag. Preferably, the monovalent ion of the intermediate solution comprises Li, W, Au, Ag, Na and/or K. More preferably, Li, W, Au and/or Ag. Most preferably, Li. The intermediate source solution may comprise anions, such as Cl, F, Br, SO₄, HCO₃, and/or CO₃. The source solution may preferably comprise Cl and/or SO₄.

The intermediate solution may comprise a ratio of divalent ions to the monovalent ion of ≤100:1, such as ≤50:1, or such as ≤30:1. The intermediate solution may comprise divalent ions in an amount of ≤16,000 ppm, such as ≤10,000 ppm or ≤6,000 ppm. The intermediate solution may comprise the monovalent ion in an amount of ≤2,700 ppm, such as ≤1,800 ppm or ≤900 ppm. The intermediate solution may comprise a ratio of divalent ions to the monovalent ion of ≥1:2, such as ≥1:1, or such as ≥1.2:1. The intermediate solution may comprise a ratio of divalent ions to the monovalent ion of ≤10:1, such as ≤5:1, or such as ≤3:1. The intermediate solution may comprise divalent ions in an amount of ≥100 ppm, such as ≥200 ppm or ≥300 ppm. The intermediate solution may comprise divalent ions in an amount of ≤2,000 ppm, such as ≤500 ppm or ≤400 ppm. The intermediate solution may comprise the monovalent ion in an amount of ≥40 ppm, such as ≥120 ppm or ≥160 ppm. It will be appreciated that the aqueous solutions may comprise other monovalent ions in addition to the target monovalent ion. The intermediate solution may comprise the monovalent ion in an amount of ≤1,600 ppm, such as ≤800 ppm or ≤400 ppm.

The product solution may comprise divalent cations, and optionally trivalent cations, such as Ca, Mg, B, Ba, Fe, Mn, Zn, Mo, Sr, Zr, V, Cr, Te, Ti, Ga, Hg, Be, In, Ta, Ce, Hf, Sm, La, Nb, Th, Al, TI, As, Ni, Cu, Sc, Sn, Sb, Co, Pb, U, Cd, Y, and/or Bi. Preferably, Ca, Mg and/or B. The monovalent ion of the source solution may comprise a cation, such as Na, K, Li, Cs, Rb, W, Au and/or Ag. Preferably, the monovalent ion of the product solution comprise Li, W, Au, Ag, Na and/or K. More preferably, Li, W, Au and/or Ag. Most preferably, Li. The source solution may comprise anions, such as Cl, F, Br, SO₄, HCO₃, and/or CO₃. The source solution may preferably comprise Cl and/or SO₄.

The product solution may comprise a ratio of the monovalent ion to divalent ions of ≥100:1, such as ≥200:1, or such as ≥300:1. The product solution may comprise divalent ions in an amount of ≤3 ppm, such as ≤2 ppm or ≤1 ppm. The product solution may comprise the monovalent ion in an amount of ≥40 ppm, such as ≥120 ppm or ≥160 ppm. It will be appreciated that the aqueous solutions may comprise other monovalent ions in addition to the target monovalent ion. The product solution may comprise the monovalent ion in an amount of ≤1,600 ppm, such as ≤800 ppm or ≤400 ppm.

The apparatus and/or process of the present invention may be operable to produce a product aqueous solution having the monovalent ion, such as lithium, retention compared to the amount of the monovalent ion, such as lithium, in the source aqueous solution of ≥65%, such as ≥70% or ≥75%.

The apparatus and/or process of the present invention may comprise a further separation portion operable to receive the product source solution after the second separation portion.

The further separation portion may comprise a separation member operable to select for a specific type of monovalent ion. For example, the further separation portion may comprise a lithium-specific separation member, such as an absorbent or extractant, operable to extract Li+ from remaining monovalent cations, such as Na+.

The further separation portion may comprise a (further, should an ion exchange separation portion is already present) ion exchange separation portion.

The apparatus and/or process of the present invention may comprise a further ion exchange separation portion, suitably operable to receive the product aqueous solution after the ‘first’ ion exchange separation portion.

The (further) ion exchange separation portion may be operable to separate the target monovalent ion from other types of monovalent ion. The (further) ion exchange separation portion may comprise a separation member operable to select for a specific type of monovalent ion. For example, the (further) ion exchange separation portion may comprise a lithium-specific separation member, such as an ion exchange resin, operable to extract Li+ from other monovalent cations that are different to the target monovalent ion, such as Na+ and K+.

The (further) ion exchange separation portion may be operable to receive the product aqueous solution and form a further refined product aqueous solution having a lower ratio of a different type of monovalent ion to the target monovalent ion. The refined product aqueous solution may be formed by recovery of the eluent in the (further) ion exchange separation portion. As such, the target monovalent ion may be retained in the eluent and other monovalent ions removed with the effluent.

In the process of the present invention, the process may further comprise:
d. contacting the product solution with a (further) ion exchange separation portion to form a refined product aqueous solution having a lower ratio of a different type of monovalent ion to the target monovalent ion.

The (further) ion-exchange resin of the ion exchange separation portion may comprise an ion-exchange resin. The (further) ion-exchange resin of the ion exchange separation portion may comprise a microporous (gel-type) and/or macroporous (porous type) resin.

The (further) ion-exchange resin may comprise a macroporous (porous type) resin.

The (further) ion-exchange resin may have a level of retention/adsorption for the target monovalent ion of ≥80%, such as ≥95% or ≥99.9%.

The (further) ion-exchange resin may have a retention/adsorption rate for monovalent ions other than the target monovalent ion of ≤20%, such as ≤10% or ≤5%.

The refined product solution may comprise divalent cations, and optionally trivalent cations, such as Ca, Mg, B, Ba, Fe, Mn, Zn, Mo, Sr, Zr, V, Cr, Te, Ti, Ga, Hg, Be, In, Ta, Ce, Hf, Sm, La, Nb, Th, Al, TI, As, Ni, Cu, Sc, Sn, Sb, Co, Pb, U, Cd, Y, and/or Bi. Preferably, Ca, Mg and/or B. The target monovalent cation of the refined product solution may comprise Na, K, Li, Cs, Rb, W, Au and/or Ag. Preferably, the target monovalent cation of the product solution comprises Li, W, Au, Ag, Na and/or K. More preferably, Li, W, Au and/or Ag. Most preferably, Li. The refined product solution may comprise anions, such as Cl, F, Br, SO₄, HCO₃, and/or CO₃. The product solution may preferably comprise Cl and/or SO₄.

The refined product solution may comprise the divalent ions in an amount of ≤10 ppm, such as ≤7 ppm or ≤5 ppm. The refined product solution may comprise the divalent ions in an amount of ≤3 ppm, such as ≤2 ppm or ≤1 ppm. The refined product solution may comprise the target monovalent ion in an amount of ≤40,000 ppm, such as ≤10,000 ppm or ≤5,000 ppm. The refined product solution may comprise the target monovalent ion in an amount of ≥100 ppm, such as ≥500 ppm or ≥1,000 ppm. It will be appreciated that the refined product solution may comprise other monovalent ions in addition to the target monovalent ion. The majority of the monovalent ions may be the target monovalent ion. The refined product solution may comprise a ratio of the divalent ions to the target monovalent ion of ≤0.02:1, such as ≤0.01:1, or such as ≤0.005:1. The refined product solution may comprise a ratio of a different type of monovalent ion to the target monovalent ion of ≤10:1, such as ≤5:1, or such as ≤1:1. This range may also apply to all other types of monovalent ion/cation that are not the target monovalent ion/cation. The refined product solution may comprise a ratio of a different type of monovalent ion to the target monovalent ion of ≤0.1:1, such as ≤0.05:1, or such as ≤0.01:1. This range may also apply to all other types of monovalent ion/cation that are not the target monovalent ion/cation.

The apparatus and/or process of any aspect of the present invention may comprise a concentration portion operable to receive the (refined) product aqueous solution and reduce the water content of the solution such as to produce a concentrated product aqueous solution. The concentration portion may comprise a membrane according to any aspect of the present invention. The concentration portion may comprise a reverse osmosis membrane.

Advantageously, the use of a reverse osmosis membrane may provide an efficient means of concentrating high purity monovalent ions solutions, such as lithium, for example before lithium carbonate is produced by evaporation/precipitation/crystallisation.

In the process of the present invention, the process may further comprise:
contacting the (refined) product solution with a concentration portion operable to receive the (refined) product aqueous solution and reduce the water content of the solution such as to produce a concentrated product aqueous solution.

The concentration portion may be contacted with the refined product solution as step (e).

The apparatus and/or process of the present invention may be operable to produce a product aqueous solution (product-, refined product- and/or concentrated-product solution) having the target monovalent ion, such as lithium, retention compared to the amount of the target monovalent ion, such as lithium, in the source aqueous solution of ≥65%, such as ≥70% or ≥75%.

The apparatus and/or process of the present invention may be operable to form a concentrated product solution comprising ≥0.5% solid content, such as ≥2% solid content, or ≥5% solid content.

The apparatus and/or process of the present invention may be operable to form a concentrated product solution comprising ≥10% of the target monovalent ion/compound thereof, such as lithium/lithium compound, by solid content, such as ≥20%, or comprising ≥50% by solids.

The apparatus and/or process of the present invention may be operable to form a concentrated product solution comprising ≥90% of the target monovalent ion/compound thereof, such as lithium/lithium compound, by solid content, such as ≥95%, or comprising ≥99% by solids.

A “lattice structure” as referred to herein, means a three-dimensional structure composing one or more repeating unit cells, wherein the cells are interconnected such as to allow for fluid flow to adjacent cells. Triply period surfaces are included as part of the term “lattice”.

The term “lamellar structure” herein means a structure having at least two overlapping layers. The term “active layer” or “membrane” herein means a porous barrier operable to separate the desired dissolved materials (solutes), colloids or particulates from the feed solutions. It may represent the interface between the feed flow and the permeate flow. The term “two-dimensional material” herein means a material with at least one dimension of less than 100 nm.

The term ‘brine’ as used herein may mean an aqueous solution of a salt.

The term ‘nanofiltration’ as used herein may refer to a separation technique that utilises a membrane to separate different components within a fluid mixture. The pore size of the nanofiltration membrane may be from 1 to 100 nm.

For the purpose of the present invention, an aliphatic group is a hydrocarbon moiety that may be straight chain (i.e. unbranched), branched, or cyclic and may be completely saturated, or contain one or more units of unsaturation, but which is not aromatic. The term “unsaturated” means a moiety that has one or more double and/or triple bonds. The term “aliphatic” is therefore intended to encompass alkyl, cycloalkyl, alkenyl cycloalkenyl, alkynyl or cycloalkenyl groups, and combinations thereof. The term “(hetero)aliphatic” encompasses both an aliphatic group and/or a heteroaliphatic group.

An aliphatic group is optionally a C₁₋₃₀ aliphatic group, that is, an aliphatic group with 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30 carbon atoms. Optionally, an aliphatic group is a C₁₋₁₅ aliphatic, optionally a C₁₋₁₂ aliphatic, optionally a C₁₋₁₀ aliphatic, optionally a C₁₋₈ aliphatic, such as a C₁₋₆aliphatic group. Suitable aliphatic groups include linear or branched, alkyl, alkenyl and alkynyl groups, and mixtures thereof such as (cycloalkyl)alkyl groups, (cycloalkenyl)alkyl groups and (cycloalkyl)alkenyl groups.

The term “alkyl,” as used herein, refers to saturated, straight- or branched-chain hydrocarbon radicals derived by removal of a single hydrogen atom from an aliphatic moiety. An alkyl group is optionally a “C₁₋₂₀ alkyl group”, that is an alkyl group that is a straight or branched chain with 1 to 20 carbons. The alkyl group therefore has 1, 2, 3, 4, 5, 6, 7, 8, 9, 10, 11, 12, 13, 14, 15, 16, 17, 18, 19 or 20 carbon atoms. Optionally, an alkyl group is a C₁₋₁₅ alkyl, optionally a C₁₋₁₂ alkyl, optionally a C₁₋₁₀ alkyl, optionally a C₁₋₈ alkyl, optionally a C₁₋₆ alkyl group. Specifically, examples of “C₁₋₂₀ alkyl group” include methyl group, ethyl group, n-propyl group, iso-propyl group, n-butyl group, iso-butyl group, sec-butyl group, tert-butyl group, sec-pentyl, iso-pentyl, n-pentyl group, neopentyl, n-hexyl group, sec-hexyl, n-heptyl group, n-octyl group, n-nonyl group, n-decyl group, n-undecyl group, n-dodecyl group, n-tridecyl group, n-tetradecyl group, n-pentadecyl group, n-hexadecyl group, n-heptadecyl group, n-octadecyl group, n-nonadecyl group, n-eicosyl group, 1,1-dimethylpropyl group, 1,2-dimethylpropyl group, 2,2-dimethylpropyl group, 1-ethylpropyl group, n-hexyl group, 1-ethyl-2-methylpropyl group, 1,1,2-trimethylpropyl group, 1-ethylbutyl group, 1-methylbutyl group, 2-methylbutyl group, 1,1-dimethylbutyl group, 1,2-dimethylbutyl group, 2,2-dimethylbutyl group, 1,3-dimethylbutyl group, 2,3-dimethylbutyl group, 2-ethylbutyl group, 2-methylpentyl group, 3-methylpentyl group and the like.

The term “alkenyl,” as used herein, denotes a group derived from the removal of a single hydrogen atom from a straight- or branched-chain aliphatic moiety having at least one carbon-carbon double bond. The term “alkynyl,” as used herein, refers to a group derived from the removal of a single hydrogen atom from a straight- or branched-chain aliphatic moiety having at least one carbon-carbon triple bond. Alkenyl and alkynyl groups are optionally “C₂₋₂₀alkenyl” and “C₂₋₂₀alkynyl”, optionally “C₂₋₁₅ alkenyl” and “C₂₋₁₅ alkynyl”, optionally “C₂₋₁₂ alkenyl” and “C₂₋₁₂ alkynyl”, optionally “C₂₋₁₀ alkenyl” and “C₂₋₁₀ alkynyl”, optionally “C₂₋₈ alkenyl” and “C₂₋₈ alkynyl”, optionally “C₂₋₆ alkenyl” and “C₂₋₆ alkynyl” groups, respectively. Examples of alkenyl groups include ethenyl, propenyl, allyl, 1,3-butadienyl, butenyl, 1-methyl-2-buten-1-yl, allyl, 1,3-butadienyl and allenyl. Examples of alkynyl groups include ethynyl, 2-propynyl (propargyl) and 1-propynyl.

The terms “cycloaliphatic”, “carbocycle”, or “carbocyclic” as used herein refer to a saturated or partially unsaturated cyclic aliphatic monocyclic or polycyclic (including fused, bridging and spiro-fused) ring system which has from 3 to 20 carbon atoms, that is an alicyclic group with 3, 4, 5, 6, 7, 8, 9, 10, 11, 12, 13, 14, 15, 16, 17, 18, 19 or 20 carbon atoms. Optionally, an alicyclic group has from 3 to 15, optionally from 3 to 12, optionally from 3 to 10, optionally from 3 to 8 carbon atoms, optionally from 3 to 6 carbons atoms. The terms “cycloaliphatic”, “carbocycle” or “carbocyclic” also include aliphatic rings that are fused to one or more aromatic or nonaromatic rings, such as tetrahydronaphthyl rings, where the point of attachment is on the aliphatic ring. A carbocyclic group may be polycyclic, e.g. bicyclic or tricyclic. It will be appreciated that the alicyclic group may comprise an alicyclic ring bearing one or more linking or non-linking alkyl substituents, such as —CH₂-cyclohexyl. Specifically, examples of carbocycles include cyclopropane, cyclobutane, cyclopentane, cyclohexane, bicycle[2,2,1]heptane, norborene, phenyl, cyclohexene, naphthalene, spiro[4.5]decane, cycloheptane, adamantane and cyclooctane.

A heteroaliphatic group (including heteroalkyl, heteroalkenyl and heteroalkynyl) is an aliphatic group as described above, which additionally contains one or more heteroatoms. Heteroaliphatic groups therefore optionally contain from 2 to 21 atoms, optionally from 2 to 16 atoms, optionally from 2 to 13 atoms, optionally from 2 to 11 atoms, optionally from 2 to 9 atoms, optionally from 2 to 7 atoms, wherein at least one atom is a carbon atom. Optional heteroatoms are selected from O, S, N, P and Si. When heteroaliphatic groups have two or more heteroatoms, the heteroatoms may be the same or different. Heteroaliphatic groups may be substituted or unsubstituted, branched or unbranched, cyclic or acyclic, and include saturated, unsaturated or partially unsaturated groups.

An alicyclic group is a saturated or partially unsaturated cyclic aliphatic monocyclic or polycyclic (including fused, bridging and spiro-fused) ring system which has from 3 to 20 carbon atoms, that is an alicyclic group with 3, 4, 5, 6, 7, 8, 9, 10, 11, 12, 13, 14, 15, 16, 17, 18, 19 or 20 carbon atoms. Optionally, an alicyclic group has from 3 to 15, optionally from 3 to 12, optionally from 3 to 10, optionally from 3 to 8 carbon atoms, optionally from 3 to 6 carbons atoms. The term “alicyclic” encompasses cycloalkyl, cycloalkenyl and cycloalkynyl groups. It will be appreciated that the alicyclic group may comprise an alicyclic ring bearing one or more linking or non-linking alkyl substituents, such as —CH₂-cyclohexyl. Specifically, examples of the C₃₋₂₀cycloalkyl group include cyclopropyl, cyclobutyl, cyclopentyl, cyclohexyl, cycloheptyl, adamantyl and cyclooctyl.

An aryl group or aryl ring is a monocyclic or polycyclic ring system having from 5 to 20 carbon atoms, wherein at least one ring in the system is aromatic and wherein each ring in the system contains three to twelve ring members. An aryl group is optionally a “C₆₋₁₂ aryl group” and is an aryl group constituted by 6, 7, 8, 9, 10, 11 or 12 carbon atoms and includes condensed ring groups such as monocyclic ring group, or bicyclic ring group and the like. Specifically, examples of “C₆₋₁₀ aryl group” include phenyl group, biphenyl group, indenyl group, anthracyl group, naphthyl group or azulenyl group and the like. It should be noted that condensed rings such as indan, benzofuran, phthalimide, phenanthridine and tetrahydro naphthalene are also included in the aryl group.

As used herein, unless otherwise expressly specified, all numbers such as those expressing values, ranges, amounts or percentages may be read as if prefaced by the word “about”, even if the term does not expressly appear. The term “about” when used herein means+/−10% of the stated value.

Singular encompasses plural and vice versa. For example, although reference is made herein to “a” channel, “a” dimensional property, and the like, one or more of each of these and any other components can be used.

Also, any numerical range recited herein is intended to include all sub-ranges subsumed therein. Singular encompasses plural and vice versa.

As used herein, the terms “on”, “applied on/over”, “extend over”, “formed on/over” and “provided on/over” mean formed or provided on but not necessarily in contact with the surface. For example, a coating “formed over” a substrate does not preclude the presence of another coating of the same or different composition located between the formed coating and the substrate.

The terms “comprising” and “comprises” as used herein are synonymous with “including” or “containing” and are inclusive or open-ended and do not exclude additional, non-recited members, elements or method steps. Additionally, although the present invention has been described in terms of “comprising”, the invention detailed herein may also be described as “consisting essentially of” or “consisting of”.

As used herein, the term “polymer” refers to oligomers and both homopolymers and copolymers, and the prefix “poly” refers to two or more. Including, for example and like terms means including for example but not limited to.

When used herein, “average” refers to mean average, unless otherwise provide for.

Where ranges are provided in relation to a genus, each range may also apply additionally and independently to any one or more of the listed species of that genus.

All of the features contained herein may be combined with any of the above aspects in any combination.

For a better understanding of the invention, and to show how aspects of the same may be carried into effect, reference will now be made, by way of example, to the following data and figures.

### BRIEF DESCRIPTION OF DRAWINGS

FIG. 1 shows a perspective view of a first embodiment of a membrane according to the present invention with unit cells based on a TPMS gyroid lattice.

FIG. 1A shows a perspective lateral cut-away view of the membrane of FIG. 1

FIG. 2 shows a perspective vertical cut-away view of the membrane of FIG. 1.

FIG. 3 shows a perspective partial cut-away view of an upper portion of the membrane of FIG. 1.

FIG. 4 shows a top view of the membrane of FIG. 1.

FIG. 5 shows a perspective view of the feed channels of the membrane of FIG. 1.

FIG. 5A shows a perspective vertical cut-away view of the feed channels of the membrane of FIG. 1.

FIG. 6 shows a perspective view of the permeate channels of the membrane of FIG. 1.

FIG. 7 shows a perspective view of a second embodiment of a membrane according to the present invention.

FIG. 7A shows a perspective vertical cut-away view of the membrane of FIG. 7.

FIG. 8 shows a perspective view of the permeate channels of the membrane of FIG. 7.

### EXAMPLES

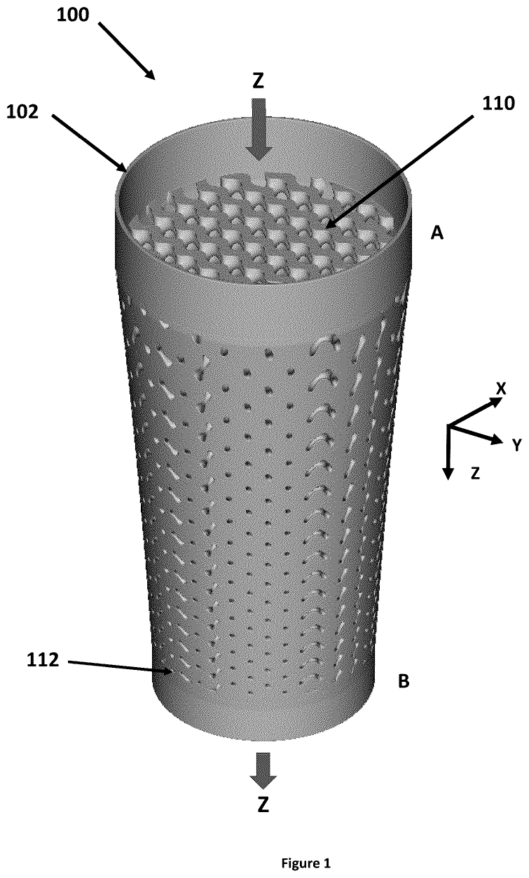

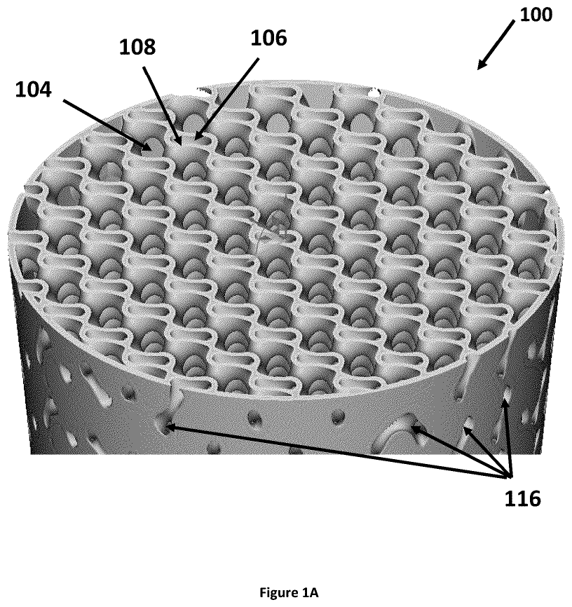

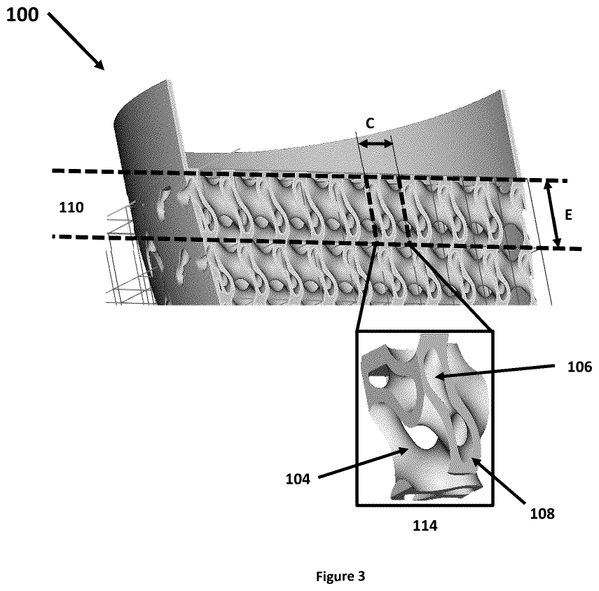

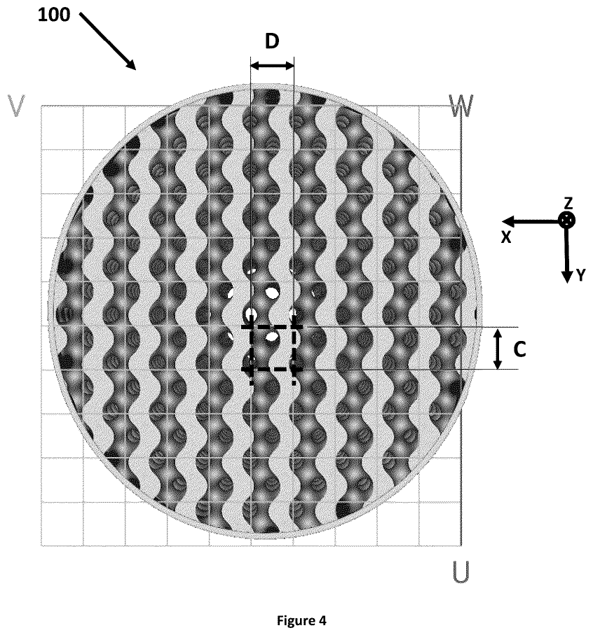

A first embodiment of a membrane (100) according to the present invention is shown in FIGS. 1-6. The first embodiment of a membrane (100) according to the present invention has a membrane interface portion (102) containing feed flow channels (104), permeate flow channels (106) and membrane portions (108) separating the two. The membrane interface portion (102) is created by a three-dimensional array of unit cells based on TPMS gyroid lattice formed of repeating unit cells and includes a network of interconnected feed flow channels (104) and permeate flow channels (106). Feed flow enters the membrane interface portion (102) in the Z direction at the proximal end A and passes through the feed flow channels (104) in the overall Z direction with the retentate existing the membrane interface portion (102) at the distal end B.

Membrane (100) has a first unit cell layer (110) arranged toward the proximal end A of the membrane interface portion (102) and a second unit cell layer (112) arranged toward the distal end B. The unit cell layers extend substantially transversely to the overall flow direction Z along the lateral directions X and Y.

Each unit cell (114) of the unit cell layers has a feed flow channel (104), a permeate flow channel (106) and a membrane portion (108) having pores allowing for fluid communication between the feed flow channels (104) and permeate flow channels (106). The feed flow channels (104) and the permeate flow channels (106) of adjacent unit cells are fluidly connected. Membrane interface portion (102) has a plurality of permeate flow outlets (116) arranged around and longitudinally along the peripheral side face. The permeate flow channels (106) are connected to the openings of the permeate flow outlets (116) on the peripheral surface of the membrane through which the permeate can exit the membrane interface portion (102).

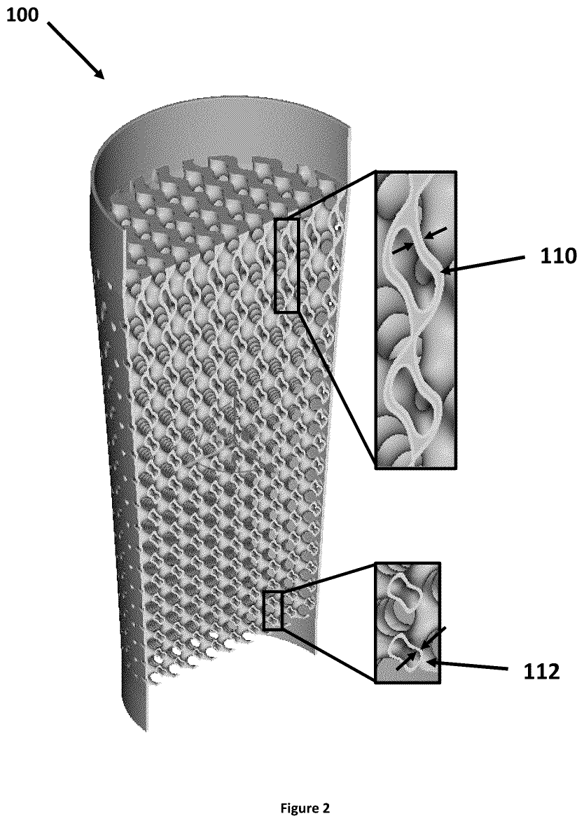

The lateral cell sizes C and D for the unit cells of the first unit cell layer (110) were 30 mm and the lateral aspect ratio reduced from 1 to 0.7 from the first unit cell layer (110) in the proximal end to the second unit cell layer (112) in the distal end. The feed flow direction cell size E for the unit cells in the first unit cell layer (110) was 50 mm and the feed flow direction aspect ratio gradually reduced from 1.7 to 0.7 from the first unit cell layer (110) at the proximal end to the second unit cell layer (112) at the distal end. As shown in FIG. 2, the thickness of the unit cell walls also reduced from 2 mm the first unit cell layer (110) at the proximal end to 1 mm in the second unit cell layer (112) at the distal end.

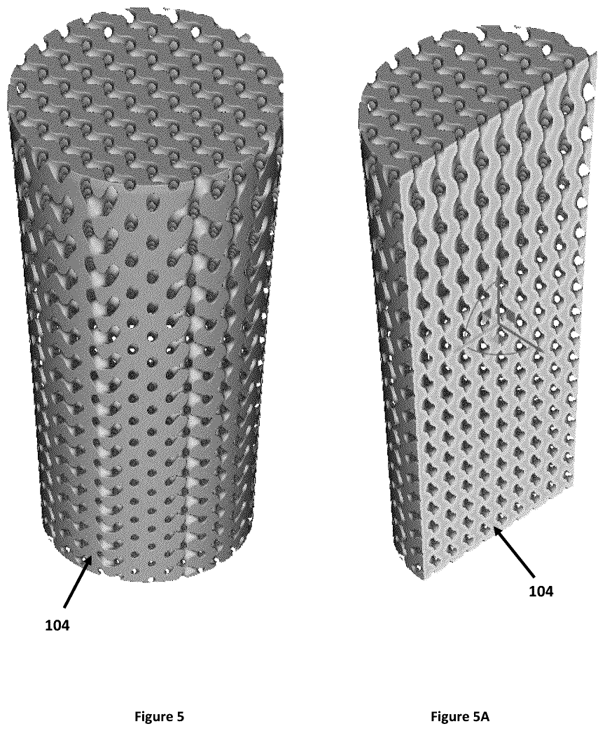

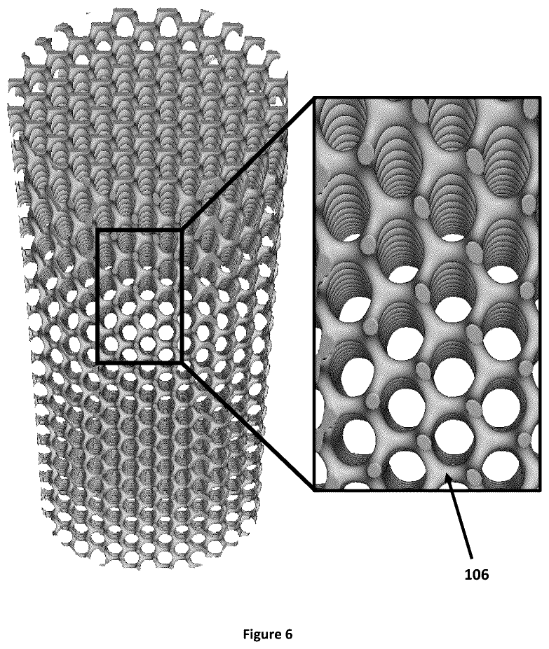

FIGS. 5 and 5A show the network of interconnected feed flow channels (104) in the membrane. FIG. 6 shows the network of permeate flow channels (106).

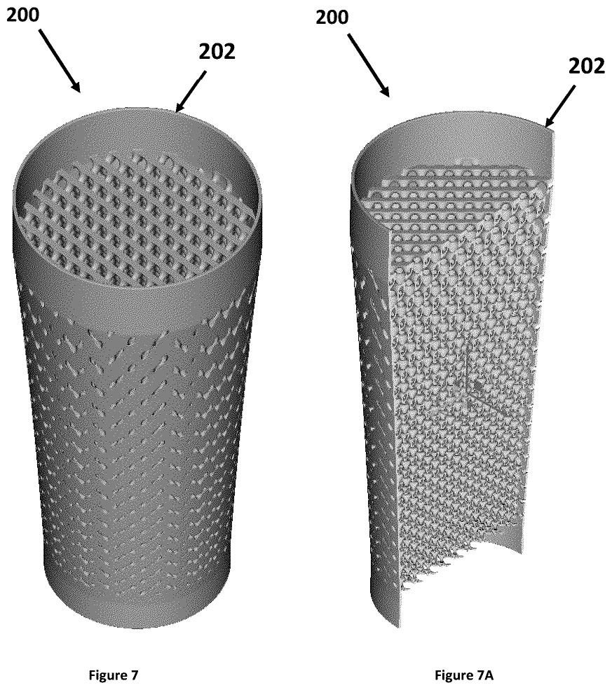

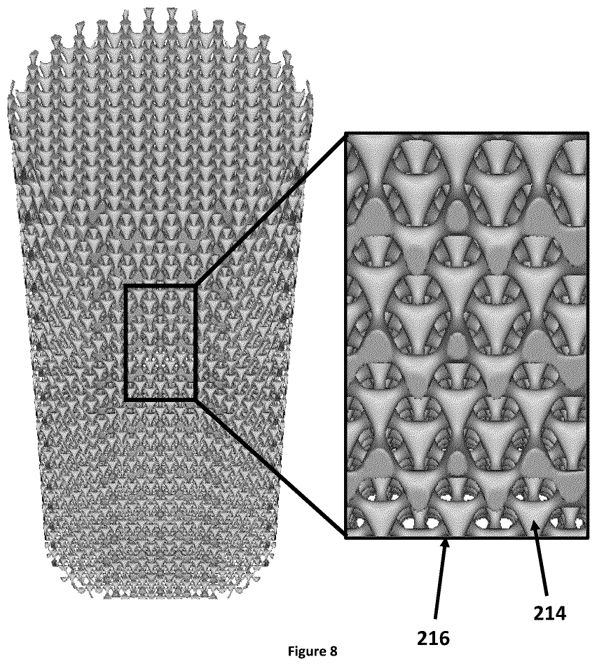

A second embodiment of a membrane (200) according to the present invention as shown in FIGS. 7-8. The membrane of the second embodiment (200) is the same as the membrane of the first embodiment (100) except that the membrane interface portion (202) is formed of a three-dimensional array of unit cells (214) based on TPMS diamond lattice (216) of repeating unit cells (214).

A membrane according to the first embodiment of the present invention was produced using additive manufacturing as described below:
Printer: Photocentric Liquid crystal Precision 1.5
Printing method: Digital Light Processing (DLP)
Printing layer height: 35 micron
Exposure time: 8 seconds

### Steps:

1. A slurry was prepared by mixing the following
   a. Ceramic powder: Almatis CL3000SG, with D50 size of 2 micron, 58.5 wt %
   b. Resin: Tethon 3D, 40 wt %
   c. Dispersant: Disperbyk-111>, 1 wt %
   d. Defoamer: Byk-1796, 0.25 wt %
   e. Photo-initiator: Omnirad 2022 by IGM resins, 0.25 wt %
2. The mixture was milled for 4 hours using ceramic grinding balls in a mixer for homogeneous distribution of ceramic powder into the resin.
3. The slurry was poured into the printer's vat and printing of the green body was initiated.
4. The green body was cleaned using an air compressor and washed in <isopropanol> and subsequently dried in an oven at 80° C. for four hours.
5. The green body was then kept in an oven at 500° C. for de-binding to burn off the volatile components. The heating rate was 0.3° C./min and the dwell time, i.e. the duration for which the temperature doesn't change, was one hour.
6. The green body was then kept in a sintering oven at 1500° C. The heating rate was 0.3° C./min and the dwell time, i.e. the duration for which the temperature doesn't change, was one hour.
7. The body was subsequently cooled to room temperature at the rate of 1° C./min to obtain a porous ceramic membrane.

Computational Fluid Dynamics (CFD) simulations were run on a representative geometry of a membrane according to the first embodiment of the present invention and compared against the results obtained for a traditional tubular membrane of the same volume where the diameter of the tubes is comparable to the feed channel width of the unit cell in the first layer while the distance between the adjacent tubes is comparable to the permeate channel width. With respect to a comparable tubular membrane, the following improvements were found for the membrane according to the present invention:
Membrane area, which has a positive influence on the permeate flow rate, was more than 30% higher.
Average shear stress on the membrane, which disrupts the concentration polarisation on the membrane surface, was more than 150% higher
Average velocity in the feed channels of the distal region, which increases the turbulence to help reduce the thickness of concentration polarisation and thus has a positive influence on the permeate flow rate, was 30% higher.

Definitions for the average shear stress and average velocity are provided below:

Average wall shear stress is area-weighted average wall shear stress on the surface of the membrane.

$$\overline{{τ}_{ω}} = \frac{1}{A} \int {τ}_{ω} dA$$

Where A is total area of the membrane interface and dA is the area of the element face in the mesh used in the simulation. Wall shear stress is obtained from:

$${τ}_{ω} = ρ u * {u}_{τ}$$

Where u* is a velocity scale in the logarithmic region of the boundary layer and is defined as:

$$u *= {C}_{μ}^{1 / 4} {k}^{1 / 2}$$

Where C_{μ} is a constant and k is turbulent kinetic energy.
And u_{τ} is defined as:

$${u}_{τ} = \frac{{U}_{t}}{\frac{1}{κ} ln ( y \text{*)} + C}$$

Where K is von Karman constant, C is log-layer constant, Uₜ is velocity tangent to the wall and y* is defined as

$$y *= ( ρ u * Δ y ) / μ$$

Where ρ is density, μ is viscosity and Δy is the perpendicular distance from the membrane surface. The average velocity in the distal region is obtained as volume-averaged velocity in the distal region.

$$\overline{v} = \frac{1}{V} \int vdV$$

Where v is the velocity and V is the volume of the distal region and dV is the volume of a mesh element in the mesh used in the simulation.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent, or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A membrane comprising:
a feed flow inlet,
a retentate flow outlet,
a permeate flow outlet,
a membrane interface portion comprising a plurality of feed flow channels fluidly connected to the feed flow inlet and to the retentate flow outlet, and a plurality of permeate flow channels fluidly connected to the permeate flow outlet, wherein the membrane interface portion is operable to allow for fluid communication between the feed flow channels and the permeate flow channels through a membrane portion,
wherein the membrane interface portion comprises a reduction in a dimensional property from toward the feed flow inlet to toward the retentate flow outlet so that the membrane interface portion is operable to produce a higher cross-flow velocity at the membrane portion toward the retentate flow outlet.

2. The membrane according to claim 1, wherein the membrane is obtainable by additive manufacturing.

3. The membrane according to claim 1, wherein the membrane interface portion comprises a first unit cell layer and a second unit cell layer, wherein each unit cell layer extends substantially transversely to the direction of feed flow, and wherein each unit cell layer comprises a plurality of unit cells,
wherein the unit cells of the first and second layer each comprise a feed flow channel portion, a permeate flow channel portion and a membrane portion separating the feed flow portion and the permeate flow portion,
wherein the feed flow channel portion and the permeate flow channel portion of a unit cell is fluidly connected to the feed flow channel portion and the permeate flow channel portion of an adjacent unit cell,
and wherein the plurality of unit cells in the first unit cell layer comprise an average dimensional property that is larger than the average of the same dimensional property in the plurality of unit cells in the second unit cell layer,
and wherein the first unit cell layer is arranged closer to the feed flow inlet than the second unit cell layer.

4. The membrane according to claim 1, wherein the membrane interface portion comprises a plurality of unit cell layers wherein the plurality of unit cells in each subsequent unit cell layer extending from proximal to the feed flow inlet to distal to the feed flow inlet have a reducing average dimensional property.

5. The membrane according to claim 1, wherein the plurality of unit cells of the first and/or second unit cell layer are in the form of periodically repeating unit cell shapes.

6. The membrane according to claim 1, wherein the first unit cell layer comprises a higher average lateral aspect ratio than the second unit cell layer.

7. The membrane according to claim 1, wherein the first unit cell layer comprises an average lateral aspect ratio of at least 0.2.

8. The membrane according to claim 1, wherein the second unit cell layer comprises an average lateral aspect ratio of at least 0.1.

9. (canceled)

10. The membrane according to claim 1, wherein the first unit cell layer comprises a higher average feed flow direction aspect ratio than the second unit cell layer.

11. The membrane according to claim 1, wherein the first unit cell layer comprises an average feed flow direction aspect ratio of at least 0.5.

12. (canceled)

13. The membrane according to claim 1, wherein the second unit cell layer comprises an average feed flow direction aspect ratio of at least 0.1.

14. (canceled)

15. The membrane according to claim 1, wherein the second unit cell layer comprises a smaller average wall thickness than the first unit cell layer.

16. The membrane according to claim 1, wherein the first unit cell layer has an average thickness ratio of at least 0.5.

17. The membrane according to claim 1, wherein the second unit cell layer has an average thickness ratio of at least 0.1.

18. The membrane according to claim 1, wherein the second unit cell layer has an average thickness ratio of up to 0.99.

19. The membrane according to a claim 1, wherein the shape of the unit cell is a diamond structure, a cubic structure, a fluorite structure, an octet structure, a Kelvin cell structure, an iso-truss structure, a hex prism diamond structure, a truncated tube structure, a truncated octahedron structure, a Weaire-Phelan structure, a body centred cubic structure, and/or a face centred cubic structure.

20. (canceled)

21. (canceled)

22. (canceled)

23. A membrane according to claim 1, wherein the membrane is a microfiltration membrane, ultrafiltration membrane and/or nanofiltration membrane.

24. (canceled)

25. (canceled)

26. (canceled)

27. (canceled)

28. (canceled)

29. (canceled)

30. The membrane according to claim 1, wherein the membrane comprises an open porosity of at least 10%.

31. (canceled)

32. (canceled)

33. (canceled)

34. (canceled)

35. (canceled)

36. The membrane according to claim 1, wherein the membrane is a ceramic membrane.

37. (canceled)

38. (canceled)

39. A process for the production of a membrane according to claim 1, the process comprising;
a. providing a layer of ceramic powder on a powder bed;
b. selectively bonding a portion of the ceramic powder; and
c. repeating steps (a)-(b) to from a 3D printed green body.

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. Apparatus for reducing the ratio of divalent ions to a monovalent ion in an aqueous solution from a source aqueous solution that contains a higher ratio of divalent ions to the monovalent ion, wherein the apparatus comprises:
a first separation portion operable to receive the prefiltered aqueous solution and form an intermediate aqueous solution having a lower ratio of divalent ions to the monovalent ion than the prefiltered aqueous solution; and/or
a second separation portion operable to receive the intermediate aqueous solution and form a product aqueous solution having a lower ratio of the divalent ions to the monovalent ion than the intermediate solution,
wherein the first and/or the second separation portion comprises a separation portion comprising a membrane according to claim 1.

75. (canceled)

76. (canceled)

77. (canceled)

78. (canceled)

79. (canceled)
